(19) United States
(12) Patent Application Publication
(10) Pub. No.: US 2026/0243909 A1
(43) Pub. Date: Aug. 20, 2026

(54) SYSTEMS AND METHODS FOR USING THE DELAYED-TIME INFORMATION TOANALYZE MODEL ACCURACY AND UPDATE MODELS

(71) Applicant: Seiswave Corporation, Katy, TX (US)

(72) Inventor: Weishan Han, Katy, TX (US)

(73) Assignee: Seiswave Corporation, Katy, TX (US)

(21) Appl. No.: 19/159,494

(22) PCT Filed: Oct. 23, 2023
(86) PCT No.: PCT/US23/35689

§ 371 Date: Aug. 25, 2025

Related U.S. Application Data
(60) Provisional application No. 63/492,827, filed on Mar. 29, 2023.

(51) Int. Cl. G01V 1/28

(52) U.S. Cl. CPC G01V 1/282; G01V 2210/679

(57) ABSTRACT

A method comprising:
receiving seismic data comprising acquired seismic waveforms that are acquired from a seismic receiver and represent a subterranean area;
generating a backward wavefield using the seismic data and based on an initial model system by propagating the backward wavefield backward in time;
generating a forward wavefield using a given wavelet or processed seismic data by propagating the forward wavefield forward in time;
generating delayed-time common image gathers (DTCIGs) based on the backward and forward wavefields;
obtaining delayed-time shift information associated with maximum amplitude of vertically prominent events produced by diving waves or model-generated reflections at each DTCIG;
extracting model accuracy information from DTCIGs for analysis and/or quality control based on the obtained delayed-time shift information;
determining a model error from either the model accuracy information and/or the DTCIGs; and
adjusting the initial model system based on the model error to generate an adjusted/updated model.

### CROSS-REFERENCES TO RELATED APPLICATIONS

This application claims the benefit of U.S. Provisional Patent Application No. 63/492,827 filed on Mar. 29, 2023, the entire content of which is hereby incorporated as reference.

### STATEMENT AS TO RIGHTS TO INVENTIONS MADE UNDER FEDERALLY SPONSORED RESEARCH AND DEVELOPMENT

NOT APPLICABLE

### TECHNICAL FIELD

The present disclosure relates generally to methods and systems for seismic exploration, more specifically, to types of full waveform inversion, by using the delayed-time information generated from seismic imaging to gauge seismic parameter model accuracy and to improve the models and seismic images of explored subsurface formations.

### BACKGROUND OF THE INVENTION

A widely used technique for searching for energy resources is seismic exploration of subsurface geophysical structures. The seismic exploration process consists of emitting seismic waves (i.e., sound waves) from a seismic energy source directed toward the subsurface area, gathering the seismic signals which are the recorded seismic waves that propagate through the earth, including reflections, refractions, and transmissions, carrying subsurface geology information, and analyzing the data to generate a profile (image) of the geophysical structure, i.e., the layers of the investigated subsurface. The last process, which generates subsurface images, is called seismic imaging. This type of seismic exploration can be used both on the subsurface of land areas and for exploring the subsurface of the ocean floor.

FIG. 1 illustrates a simplified, schematic view of marine seismic gathering process when a reservoir 100 is present in the surveyed formation 110 under the seafloor 120. Vessel 130 tows a seismic source 140. Many receivers, 150, are situated either in the water (towed streamer acquisition), or on the seafloor (ocean bottom node/cable acquisition) or along a well trace inside the earth (vertical seismic profile acquisition). The source generates seismic excitations that penetrate the seafloor and travel through the surveyed formation 110 before being detected and recorded by the receivers, which then generate seismic data. Although we illustrate seismic data acquisition using marine data acquisition setting, embodiments of the present disclosure apply to all kinds of seismic data, including any type of marine and land seismic surveys, acquired by various types of sources (airgun, vibrator, dynamite, etc.) and receivers (geophone, hydrophone, distributed acoustic sensor, etc.).

The recorded data is then processed to produce accurate subsurface models of rock properties of the surveyed formation, or less desirably, a quality image of the surveyed formation structure. Consequently, using these subsurface rock property or formation models or images, geophysicists can identify sweet spot for possible reservoir, and petroleum engineers can design and develop methods for extracting these natural resources trapped in the reservoir deposits based on geomechanical analysis.

Subsurface models are key components of seismic processing and imaging. As its name implies, models are visual representations of the (physical or mathematical) properties in different locations underground. These may include, but are not limited to, p-wave velocity model, s-wave velocity model, anisotropy models, elastic parameters, Q model (to describe subsurface attenuation), density model and etc. Note that “underground” can mean in land-based areas, or underground under the ocean floor (but can also include the different velocities of the sound waves as they passed through different ocean water layers). Using these models, the seismic data in their travel time, amplitude, phase, etc. can be described or simulated at all subsurface locations of the models.

FIG. 2 illustrates a simplified, synthetic towed streamer seismic data acquired for the surveyed formation using the Sigsbee2a stratigraphic p-wave velocity model (Paffenholz, J., B. McLain, J. Zaske, and P. Keliher, 2002, “Subsalt multiple attenuation and imaging: Observations from the Sigsbee2B synthetic dataset”: 72nd Annual International Meeting, SEG, Expanded Abstracts, 2122-2125) in FIG. 3a. The seismic data is acquired in a towed streamer acquisition setting where a common source seismic record display is presented in FIG. 2a and a common channel seismic record display is presented in FIG. 2b. Ideally, if the stratigraphic velocity model in FIG. 3a can be retrieved using these acquired data in FIG. 2, one could easily directly interpret the main salt body in black color (high velocity) at the middle, the treading sea floor and scattered gas pockets in gray color (contrasted to their surrounding velocity) in the shallow and the mud formation in black color (high velocity) horizontally at the bottom. Next to the best, at end of the processing stage, one could retrieve the (reflectivity) image in FIG. 3b. In this case, using the image and together with some complicated rock properties inversion process, one can still retrieve the velocity model in FIG. 3a and thus the ideal benefits of the seismic survey.

However, it is known that there are many different geological factors that can make it difficult to create accurate depictions of the models. For example, some subsurface areas have significant complex features such as strong velocity or anisotropic parameter variations, or complex geological formations such as salt and basalt structures, heavily faulted zones, anisotropic environments due to sedimentation or fracturing (an anisotropic environment is one in which seismic waves move at higher or lower velocities depending upon whether they move in directions along or across rock bed layers), overthrusts, shallow gas, and others. The processing of the reflected, refracted, and transmitted sound waves can therefore become extremely complicated.

FIG. 4a illustrates the Sigsbee2a p-wave migration velocity model (Paffenholz, J., B. McLain, J. Zaske, and P. Keliher, 2002, “Subsalt multiple attenuation and imaging: Observations from the Sigsbee2B synthetic dataset”: 72nd Annual International Meeting, SEG, Expanded Abstracts, 2122-2125) representing the basic background geological formation of the exact Sigsbee2a stratigraphic p-wave velocity model in FIG. 3a for the proposing of imaging. Using the acquired data in FIG. 2, one could adapt the migration velocity model and establish an image as in FIG. 4b. Without an accurate velocity model as in FIG. 3a, the quality of the image in FIG. 4b degrade significantly when compared to the one in FIG. 3b.

Another simplified example of the model system, the 2007 BP tilted transversely isotropic (TTI) benchmark created by Hemang Shah and BP Exploration Operation Company Limited, is demonstrated in FIGS. 5, 6 and 7. FIGS. 5a and 5b illustrate a seismic dataset synthetized using typical rock properties in the Gulf of Mexico gathered in common source and common receiver, respectively. FIGS. 6a, 6b, 7a and 7b present the P-wave velocity, anisotropic Thomsen parameter δ model, anisotropic Thomsen parameter F model and anisotropic polarization angle θ of the surveyed formation, respectively. Using the recorded data in FIG. 5 and the TTI model system in FIGS. 6 and 7, we can retrieve the subsurface image in FIG. 8 via migration.

Full waveform inversion (FWI) has been an important method to build velocity models for seismic imaging (see, Tarantola, A., 1984, “Inversion of Seismic Reflection Data in the Acoustic Approximation”: Geophysics, 49, 1259-1266; and Virieux, J., and S. Operto, 2009, “An Overview of Full Waveform Inversion in Exploration Geophysics”, Geophysics, 74(6), WCC127-WCC152). A classical FWI inverts velocity models by iteratively minimizing the difference between the recorded field data and simulated model data. However, two major issues may cause FWI to fail in production: cycle-skipping and amplitude discrepancy between the field and model data, particularly when there are sharp contrasts and large-scale geobodies in the model. When the phases, or traveltime differences, between field and model data are large, the oscillatory pattern of the seismic signals introduces local minima. FWI may attempt to fit the simulated model data to a wrong cycle in the observed field data. Additionally, the amplitude distribution of observed field data is usually very different from that of modeled. If this difference is not appropriately addressed, it will be interpreted as velocity error by FWI, which can lead to the inversion of erroneous velocity models.

Since the traveltime difference of seismic signals is more linearly related to velocity error than waveform difference and any discrepancies in the amplitude difference are inconsequential, extracting the traveltime information of field data effectively lies at the heart of velocity model building and the application of FWI. To achieve this, researchers have made many influential advancements such as adaptive waveform inversion (Warner and Guasch, 2014, “Adaptive waveform inversion”: 84th Annual International Meeting, SEG, Expanded Abstracts, 1089-1093), dynamic-warping FWI (Ma and Hale, 2013, “Wave-equation reflection traveltime inversion with dynamic warping and hybrid waveform inversion”: 83rd Annual International Meeting, SEG, Expanded Abstracts, 871-876), time-lag FWI (Luo and Schuster, 1991, “Wave-equation traveltime inversion”: Geophysics, 56, 645-653) and optimal transport FWI (Yang et al., 2018, “Application of optimal transport and the quadratic Wasserstein metric to full-waveform inversion”: Geophysics, 83, 43-62.).

All the aforementioned methods are formulated in the conventional data domain only, and their success relies on the extraction of traveltime misfit between recorded field and modeled data. However, extracting traveltime misfit in data domain is not trivial. When geology is complex, the waveforms are complicated, several reflection, refraction or transmission events may overlay each other when they are recorded. On the other hand, if the initial velocity is simple and far away from the correct one, the modeled synthetic waveforms appear much simpler, with significant traveltime and amplitude differences. Therefore, it is not obvious how to correctly measure traveltime misfit by comparing the two datasets. In summary, there is no guarantee that a data domain traveltime misfit based FWI can overcome cycle-skipping issue when the survey geology is complex or when FWI starts from a poor initial velocity model.

Considering the limitations inherent in existing methodologies, there exists a demand for innovative systems and methods that furnish a pragmatic and effective framework. These would ensure the inversion of field data for subsurface velocity distribution, unaffected by cycle-skipping issues, through measurements in the image domain, and precisely and practically gauge velocity model accuracy. This document introduces an enhanced system and methods that adeptly fulfill these dual objectives.

### SUMMARY OF THE INVENTION

An object of the embodiments is to substantially solve the cycle-skipping and amplitude discrepancy issues which may cause a classical FWI to fail to converge to a reasonably good geological model system. Here, the model system describes the geophysical properties at the subsurface locations may include, but is not limited to, p-wave velocity model, s-wave velocity model, anisotropy models, elastic parameters, Q model (to describe subsurface attenuation), density model and etc.

It is therefore a general aspect of the embodiments to provide a system and method for improving the application of FWI to a seismic survey to obtain better model resolution that will obviate or minimize problems of the type previously described.

Some embodiments use enhanced FWI approaches to determine the models of surveyed subsurface formations. One approach uses delayed-time information to not only measure the model accuracy, but also provide feedback to FWI for model updating. These approaches solve the issues of cycle-skipping and amplitude discrepancy observed when classical FWI is used to process seismic data acquired for a surveyed formation.

According to an embodiment, there is a method for seismic exploration. The method includes obtaining initial models and recorded field data for a surveyed subsurface formation and generating the delayed-time domain common imaging gathers (DTCIGs) based on the initial models. The method further includes extracting delayed-time shift value at the subsurface location. One example of this extraction process can be defined by selecting the imaging point with the maximum amplitude along the delayed-time direction. The method then includes using the delayed-time shift information to quantify, analyze, or quality control the velocity accuracy. The method then includes updating the models using an optimization scheme (such as FWI) with a cost function minimizing the total delayed-time shifts at the subsurface locations. The updated models are used to obtain an image of the surveyed subsurface formation usable to locate natural resources.

According to another embodiment, there is a seismic data processing apparatus having an interface and a data processing unit. The interface is configured to obtain initial models and recorded data for a surveyed subsurface formation. The data processing unit is configured to generate DTCIGs based on the initial models, to determine delayed-time shifts on DTCIGs at subsurface locations, to quantify, analyze, or quality control the model accuracy using the delayed-time shift information, and to update the models using an optimization scheme (such as FWI) with a cost function minimizing the total delayed-time shifts at the subsurface locations. Here too the updated models are used to obtain an image of the surveyed subsurface formation usable to locate natural resources.

According to yet another embodiment, there is a non-transitory computer-readable recording media storing executable codes which when executed by a computer make the computer perform a method for seismic exploration. The method includes obtaining initial models and recorded data for a surveyed subsurface formation and generating the DTCIGs based on the initial models. The method further includes determining delayed-time shifts on DTCIGs at subsurface locations. The method then includes using the delayed-time shift information to quantify, analyze, or quality control the velocity accuracy. The method then includes updating the models using an optimization scheme (such as FWI) with a cost function minimizing the total delayed-time shifts at the subsurface locations. The updated models are used to obtain an image of the surveyed subsurface formation usable to locate natural resources.

To locate natural resources, the obtained image can be further analyzed using geoscientific techniques, such as seismic interpretation or reservoir characterization. These techniques can identify areas with favorable geological conditions, such as hydrocarbon-bearing reservoirs, mineral deposits, or other resources of interest. By combining these techniques with the updated models, it is possible to more accurately predict the location of natural resources within the subsurface formation. The detailed steps to support these implementations are specified in 1. Brown, A. R., 2011, “Interpretation of Three-Dimensional Seismic Data”: Society of Exploration Geophysicists and American Association of Petroleum Geologists. 2. Chopra, S., & Marfurt, K. J., 2007, “Seismic Attributes for Prospect Identification and Reservoir Characterization”: Society of Exploration Geophysicists. 3. U.S. Pat. No. 8,543,623, titled “Method for generating a subsurface model and method for hydrocarbon prospecting,” filed on May 12, 2010. Each of these references is incorporated herein as reference.

### BRIEF DESCRIPTION OF THE DRAWINGS

For a more complete understanding of the present invention, reference is now made to the following descriptions taken in conjunction with the accompanying drawing, in which:

FIG. 1 is a schematic diagram of a conventional seismic data acquisition.

FIG. 2 illustrates a synthetic seismic data acquired for the surveyed formation using the Sigsbee2a stratigraphic p-wave velocity model in FIG. 3a. A typical common shot seismic record and a typical common channel seismic record is displayed in FIGS. 2a and 2b, respectively.

FIG. 3a illustrates the Sigsbee2a stratigraphic p-wave velocity model, and FIG. 3b illustrates the Sigsbee2a stratigraphic reflectivity model.

FIG. 4a illustrates the Sigsbee2a migration p-wave velocity model, and FIG. 4b illustrates the Sigsbee2a migration image established using the seismic data in FIG. 2 and the migration velocity in FIG. 3a via a reverse time migration tool.

FIGS. 5a and 5b illustrate a seismic dataset the gathered in common source and common receiver, respectively. This dataset is from the 2007 BP tilted transversely isotropic (TTI) benchmark created by Hemang Shah and BP Exploration Operation Company Limited.

FIGS. 6a and 6b illustrate the P-wave velocity and anisotropic Thomsen parameter δ model from the 2007 BP tilted transversely isotropic (TTI) benchmark, respectively.

FIGS. 7a and 7b illustrate the anisotropic Thomsen parameter F model and anisotropic polarization angle θ of the surveyed formation from the 2007 BP tilted transversely isotropic (TTI) benchmark, respectively.

FIG. 8 illustrates migration image established using the seismic data in FIG. 5 and the TTI velocity models in FIGS. 6a, 6b, 7a and 7b via a reverse time migration tool.

FIG. 9 illustrates a flowchart of a method to measure, analyze, or quality control the model accuracy using the DTCIGs, according to an embodiment.

FIG. 10a illustrates the exact p-wave velocity model. FIG. 10b illustrates a typical common shot seismic data simulated using the velocity in FIG. 10a, as at system 902.

FIG. 11a illustrates the initial p-wave velocity model to start the velocity analyze or model update proceed as at system 904. FIG. 11b illustrates a typical wavelet as at system 906.

FIG. 12a illustrates a snapshot of the backward wavefield backward propagating in time through the surveyed formation in FIG. 11a as at system 908. FIG. 12b illustrates a snapshot of the forward wavefield forward propagating in time through the surveyed formation in FIG. 11a as at system 910.

FIG. 13a and FIG. 13b illustrate a DTCIG using the raw wavefields and the processed wavefields through the initial model system at a typical spatial position of the surveyed formation as at system 912, respectively. The white line indicates the picked maximum amplitude along the delayed-time direction for all depths. The dashed line indicates the 0 delayed-time lag.

FIG. 14a and FIG. 14b illustrate a DTCIG using the raw wavefields and the processed wavefields through the exact model system in FIG. 10a at the same spatial position of the surveyed formation as in FIG. 13, respectively. The white line indicates the picked maximum amplitude along the delayed-time direction for all depths. The dashed line indicates the 0 delayed-time lag.

FIG. 15 illustrates a velocity accuracy/error attribute extracted from the DTCIGs in FIG. 13 using equation (6) for all locations of the surveyed formation as at system 914.

FIG. 16a and FIG. 16b illustrate the SEAM exact p-wave velocity model at inline 875 and crossline 1001, respectively.

FIG. 17a and FIG. 17b illustrate the SEAM exact anisotropic Thomsen parameter δ model at inline 875 and crossline 1001, respectively.

FIG. 18a and FIG. 18b illustrate the SEAM exact anisotropic Thomsen parameter ε model at inline 875 and crossline 1001, respectively.

FIG. 19a and FIG. 19b illustrate the SEAM exact anisotropic Thomsen parameter dip model at inline 875 and crossline 1001, respectively.

FIG. 20a and FIG. 20b illustrate the SEAM exact anisotropic Thomsen parameter azimuth model at inline 875 and crossline 1001, respectively.

FIG. 21a and FIG. 21b illustrate the SEAM exact density model at inline 875 and crossline 1001, respectively.

FIG. 22a illustrates a typical wavelet as at system 906. FIG. 22b illustrates a typical common receiver seismic data simulated using the velocity in FIGS. 16, 17, 18, 19, 20 and 21, as at system 902.

FIG. 23a and FIG. 23b illustrate the initial p-wave velocity model to start the velocity analyze or model update proceed as at system 904 at inline 875 and crossline 1001, respectively.

FIG. 24a and FIG. 24b illustrate difference between the initial p-wave velocity model in FIG. 23 compared to exact p-wave velocity model in FIG. 16 at inline 875 and crossline 1001, respectively.

FIG. 25a illustrates a snapshot of the backward wavefield backward propagating in time through the surveyed formation in FIG. 23 as at system 908. FIG. 25b illustrates a snapshot of the forward wavefield forward propagating in time through the surveyed formation in FIG. 23 as at system 910.

FIG. 26a, FIG. 26b, FIG. 26c, and FIG. 26d illustrate a DTCIG using the raw wavefields through the initial model system in FIG. 23 at crossline 401, 801, 1201 and 1601 for inline 1001 of the surveyed formation as at system 912, respectively.

FIG. 27a, FIG. 27b, FIG. 27c, and FIG. 27d illustrate a DTCIG using the processed wavefields through the initial model system in FIG. 23 at crossline 401, 801, 1201 and 1601 for inline 1001 of the surveyed formation as at system 912, respectively. The white line indicates the picked maximum amplitude along the delayed-time direction for all depths. The dashed line indicates the 0 delayed-time lag.

FIG. 28a and FIG. 28b Illustrate a velocity accuracy/error attribute extracted from the DTCIGs in FIG. 27 using equation (6) of the surveyed formation as at system 914 at inline 875 and crossline 1001, respectively. The gray line indicates the uncertainty boundary below which the velocity accuracy/error attribute is no longer accurate due to the lack of wave penetration and delay time gather focusing.

FIG. 29a and FIG. 29b illustrate a velocity accuracy/error attribute extracted from the DTCIGs in FIG. 27 using equation (6) of the surveyed formation as at system 914 at depth 5000 m and 6000 m, respectively.

FIG. 30a, FIG. 30b, FIG. 30c, and FIG. 30d illustrate a DTCIG using the raw wavefields through the exact model system in FIG. 16 at crossline 401, 801, 1201 and 1601 for inline 1001 of the surveyed formation as at system 912, respectively.

FIG. 31a, FIG. 31b, FIG. 31c, and FIG. 31d illustrate a DTCIG using the processed wavefields through the initial model system in FIG. 16 at crossline 401, 801, 1201 and 1601 for inline 1001 of the surveyed formation as at system 912, respectively. The white line indicates the picked maximum amplitude along the delayed-time direction for all depths. The dashed line indicates the 0 delayed-time lag.

FIG. 32a and FIG. 32b Illustrate a velocity accuracy/error attribute extracted from the DTCIGs in FIG. 31 using equation (6) of the surveyed formation as at system 914 at inline 875 and crossline 1001, respectively. The gray line indicates the uncertainty boundary below which the velocity accuracy/error attribute is no longer accurate due to the lack of wave penetration and delay time gather focusing.

FIG. 33a and FIG. 33b Illustrate a velocity accuracy/error attribute extracted from the DTCIGs in FIG. 31 using equation (6) of the surveyed formation as at system 914 at depth 5000 m and 6000 m, respectively.

FIG. 34 illustrates a flowchart of a process to determine model error and model update, according to an embodiment.

FIG. 35 illustrates a flowchart of a process to update models in an iterative way, according to an embodiment.

FIG. 36a illustrates a rescaled velocity gradient using the velocity accuracy/error attribute in FIG. 15. It is a process required in equation (7) and for system 3414, 3416, 3514, and 3516. FIG. 36b illustrates an updated velocity using the velocity gradient in FIG. 36a and the initial velocity model in FIG. 11a. It is a process required in equation (7) and for system 3416, 3516, and 3518.

FIG. 37 illustrates a block diagram of an example computing system.

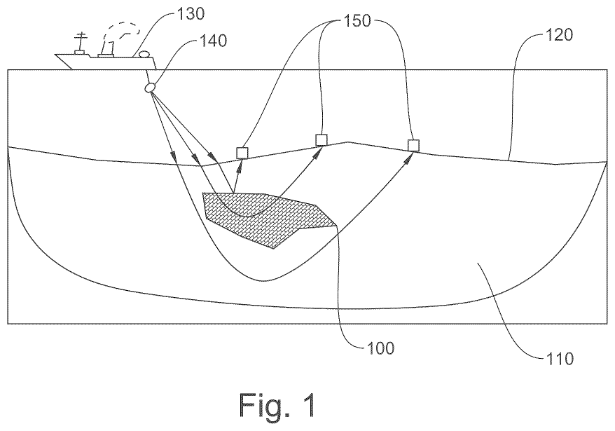

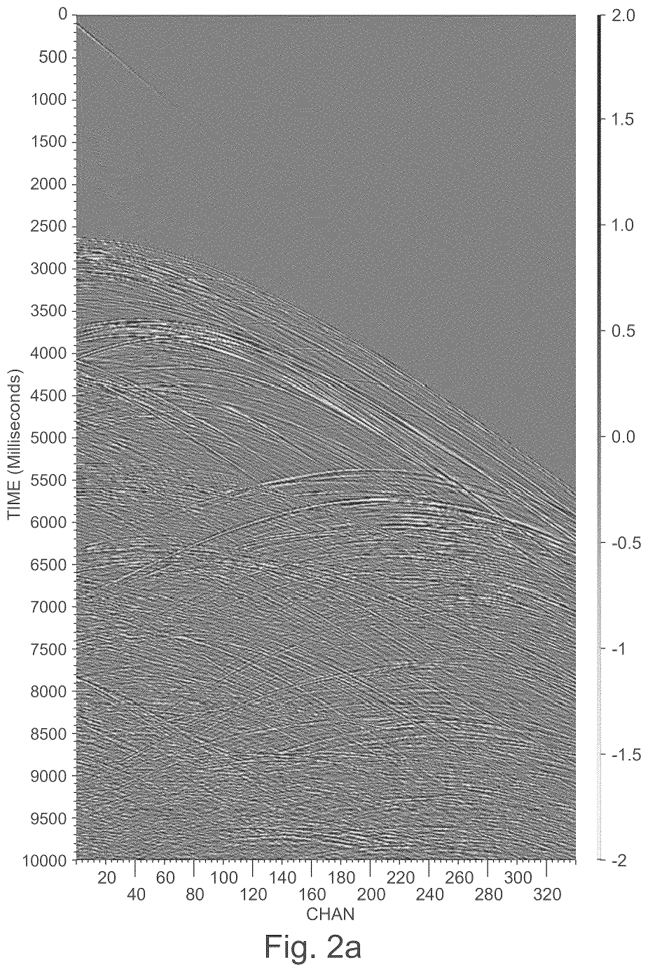

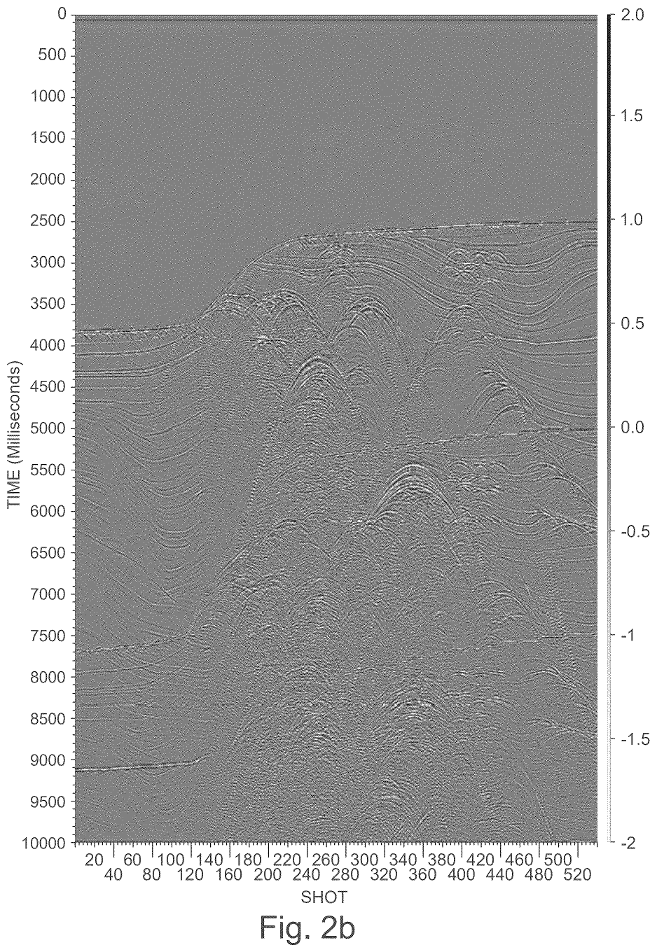

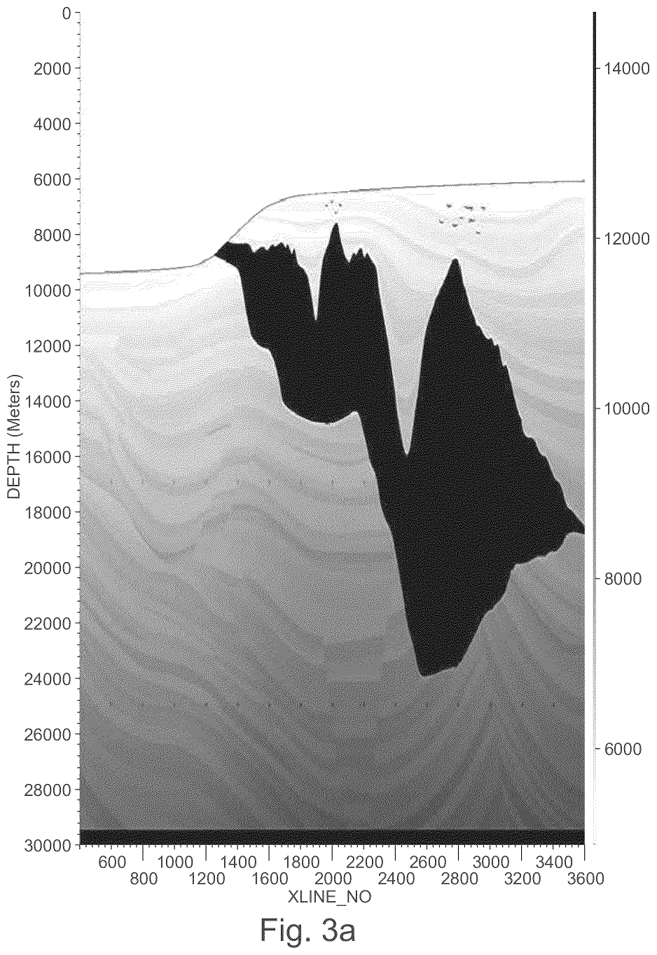

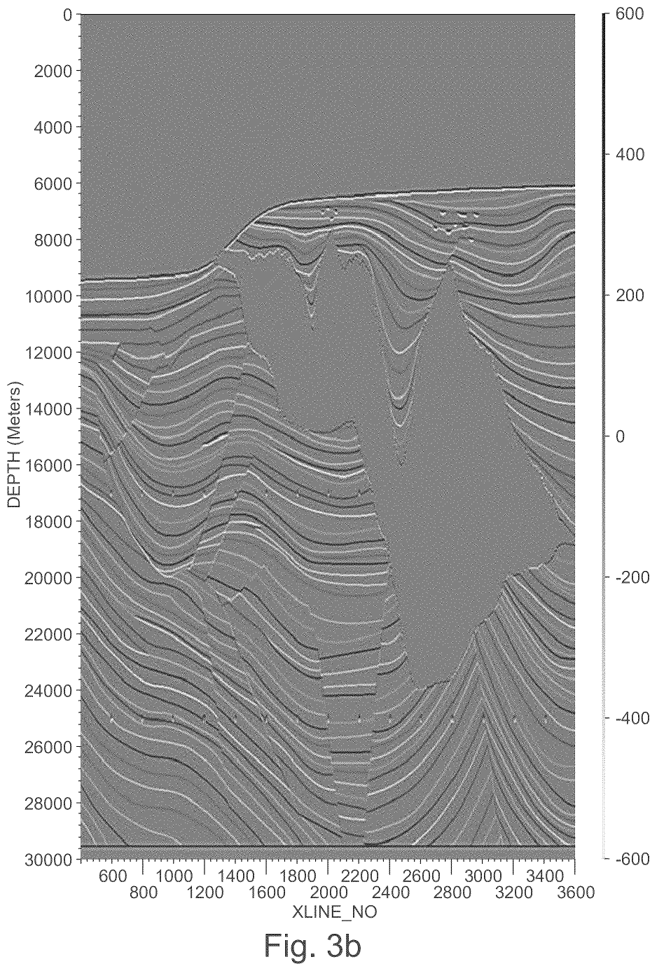

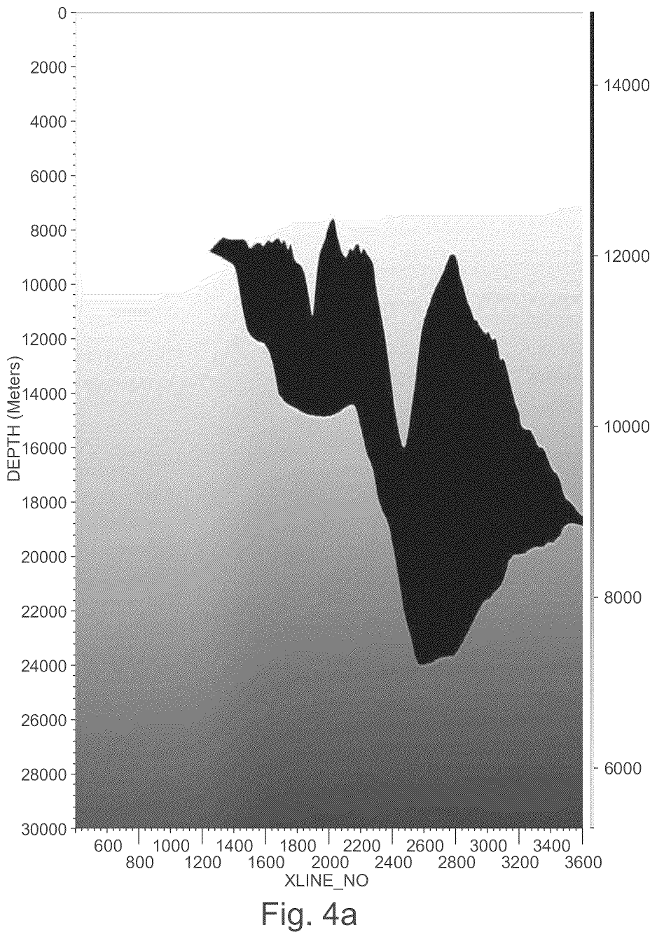

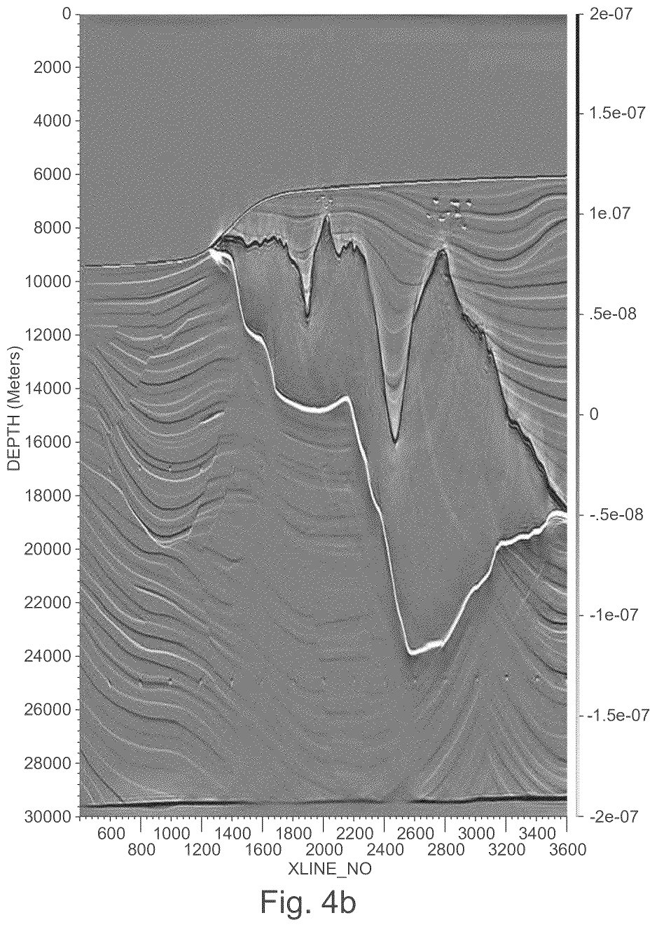

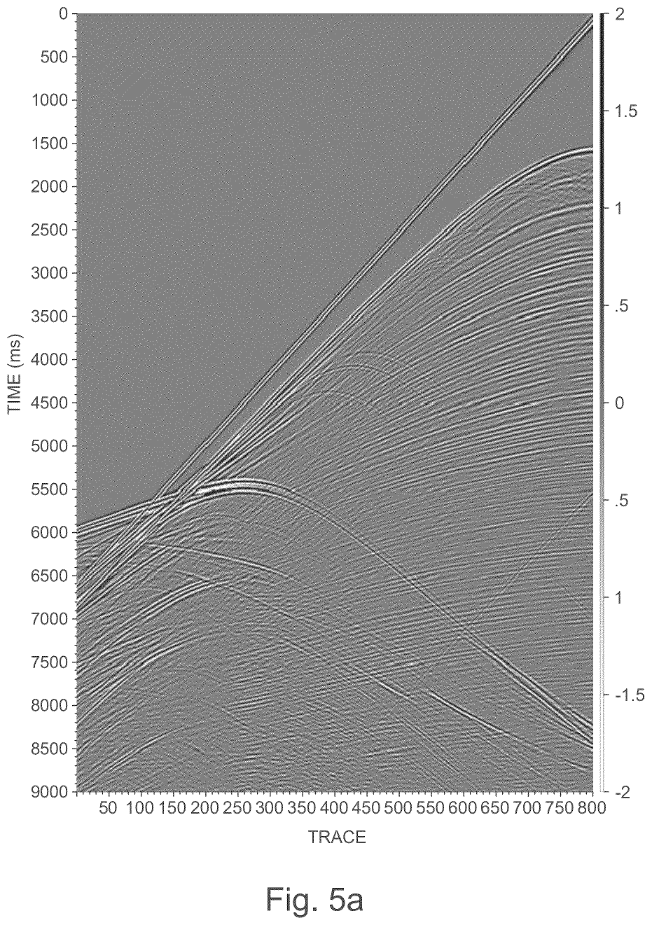

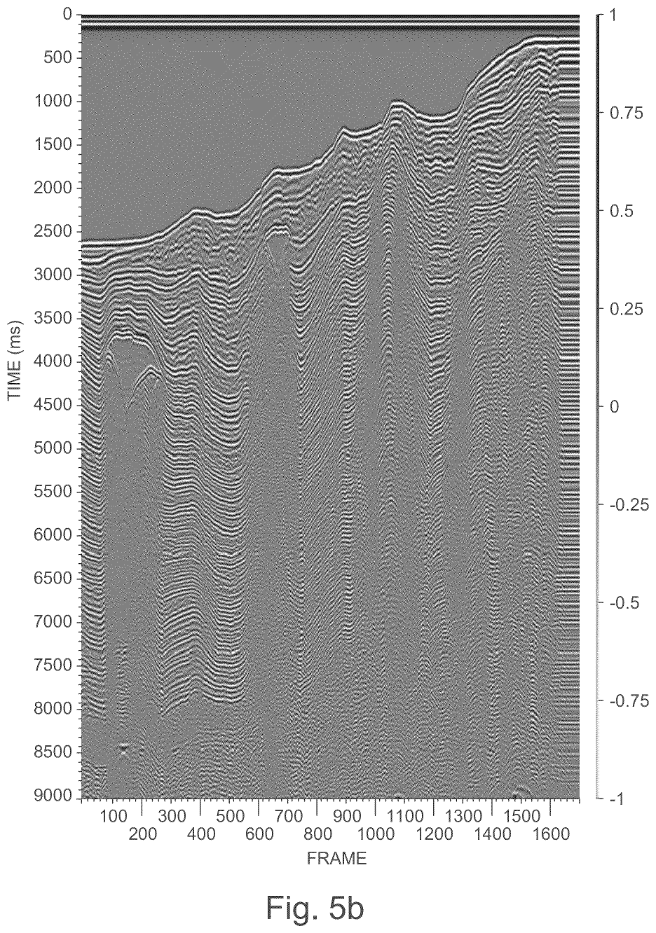

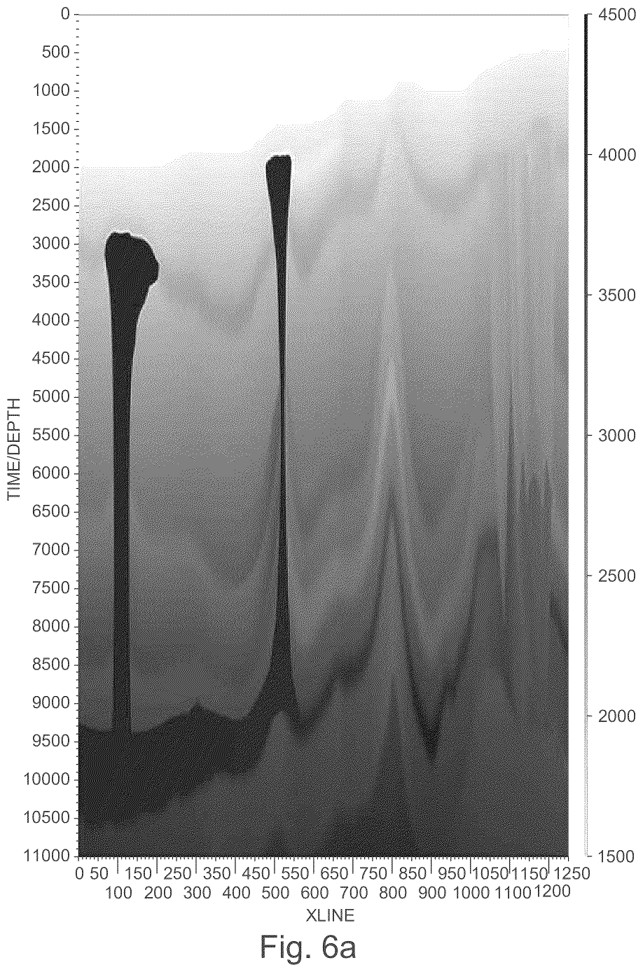

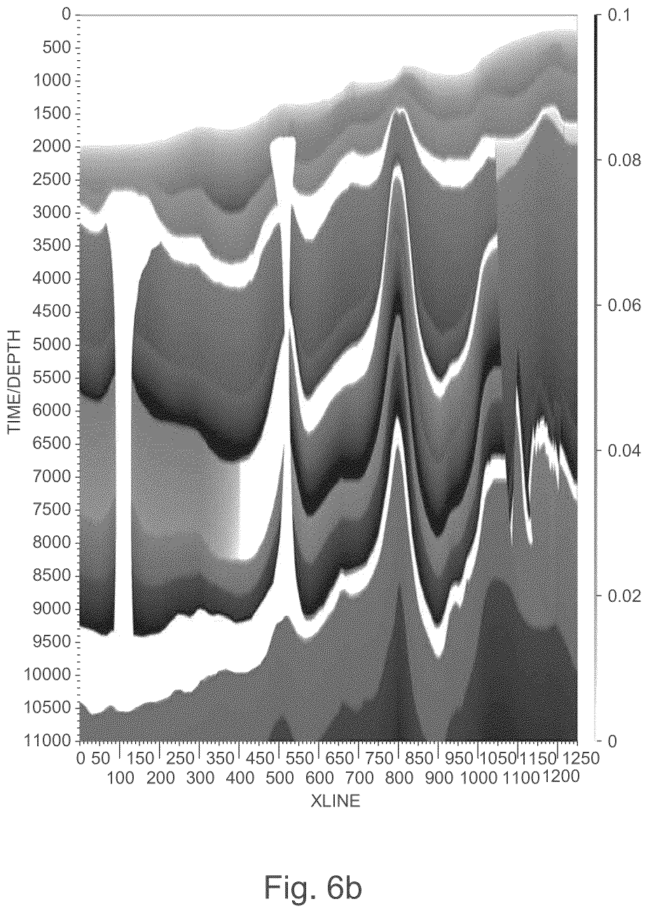

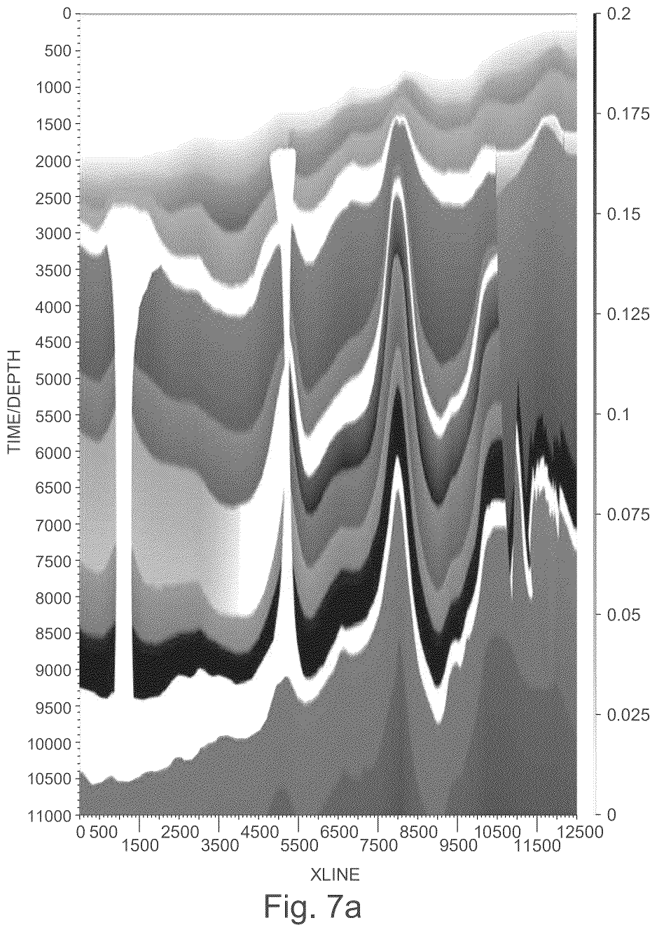

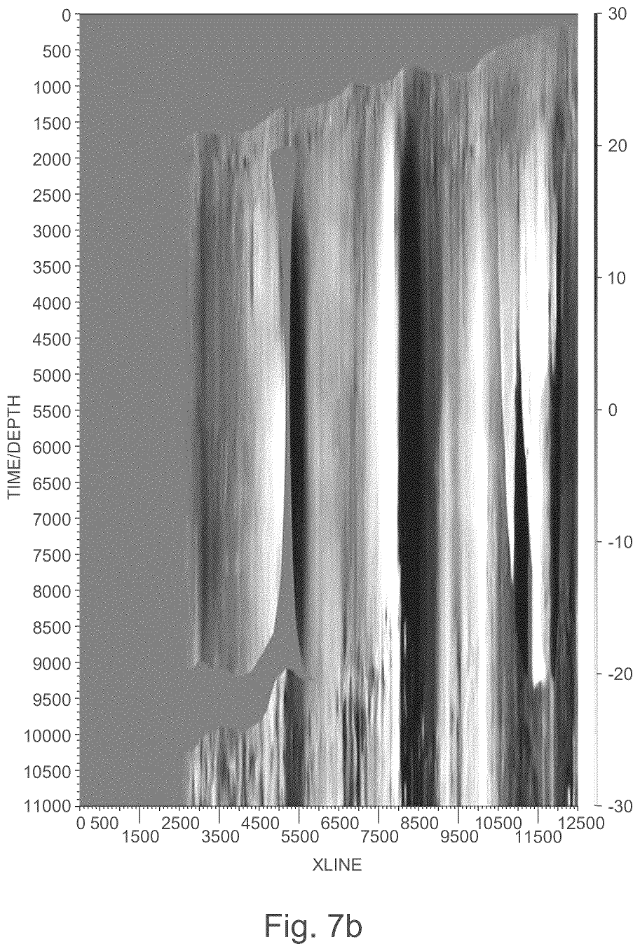

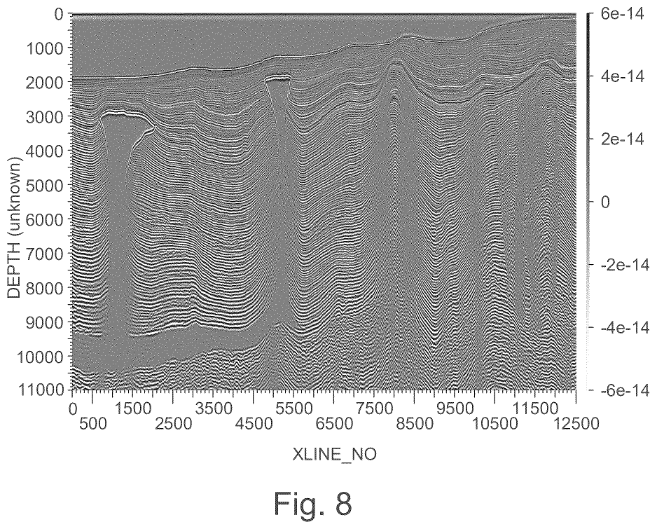

### DETAILED DESCRIPTION OF THE INVENTION

The following description of the exemplary embodiments refers to accompanying drawings. The same reference numbers in different drawings identify the same or similar elements. The following detailed description does not limit the invention. Instead, the scope of the invention is defined by the appended claims. The following embodiments are discussed using the terminology of seismic data acquisition and processing.

Reference throughout the specification to “one embodiment” or “an embodiment” means that a particular feature, structure, or characteristic described in connection with an embodiment is included in at least one embodiment of the disclosed subject matter. Thus, the appearance of the phrases “in one embodiment” or “in an embodiment” in various places throughout the specification does not necessarily refer to the same embodiment. Furthermore, the particular features, structures or characteristics may be combined in any suitable manner in one or more embodiments.

Classic FWI seeks to obtain an optimal velocity model v(\vec{x}) of the surveyed formation by minimizing the following least-squares amplitude misfit objective function:

$$E ( v ) = \frac{1}{2} \int \int \int {( F ( v ) ( t ; {\vec{x}}_{r} ; {\vec{x}}_{s} ) - d ( t ; {\vec{x}}_{r} ; {\vec{x}}_{s} ) )}^{2} dt d {\vec{x}}_{r} d {\vec{x}}_{s} . \qquad ( 1 )$$

Here, t represents time, \vec{x}ₛ, and \vec{x}ᵣ denote the location of source and receiver, respectively. \vec{x} is used to denote a subsurface location within the surveyed formation. d refers to the seismic data recorded in the field, F(v) stands for wave equation simulator, which simulates data by solving wave equations with numerical algorithms, such as finite difference, finite element, or finite volume, on possible subsurface velocity models v.

Two major issues can cause classic FWI to fail in production: cycle-skipping and amplitude discrepancy between the field data, d, and modeled data, u=F(v). First, if the initial model is far from the true model, the difference in waveform between the field and model data becomes significant, and the oscillatory pattern of the seismic signals introduces local minima. As a result, FWI may attempt to fit the model data to a wrong cycle in the field data, leading FWI to converge to an incorrect velocity. Secondly, the amplitude distribution of observed field data is often markedly different from that of the modeled data. If this difference is not appropriately addressed, FWI can misinterpret it as a velocity error, leading to the inversion of erroneous velocity models. Additionally, the amplitude of field data is not solely determined by the velocity model but also influenced by other subsurface attributes, such as density. Thus, even a correct velocity model cannot guarantee that the amplitude of model data matches that of field data. Many solutions have been proposed to address cycle-skipping and amplitude discrepancy issues in FWI. However, most of these methods are formulated solely in the classic data domain, and their success depends on extracting travel-time misfit between the field data and model data, which is not a trivial task.

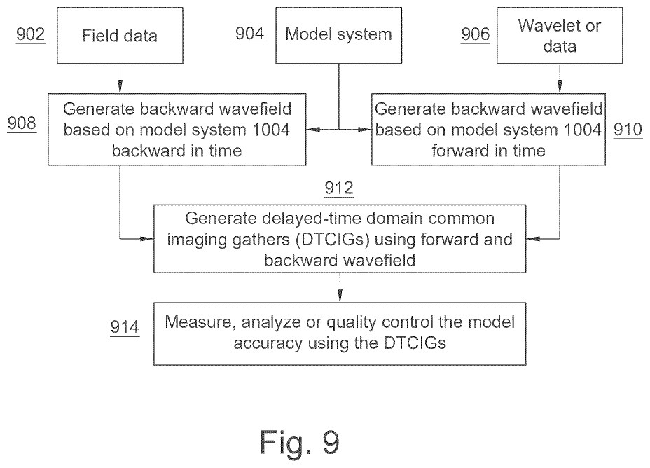

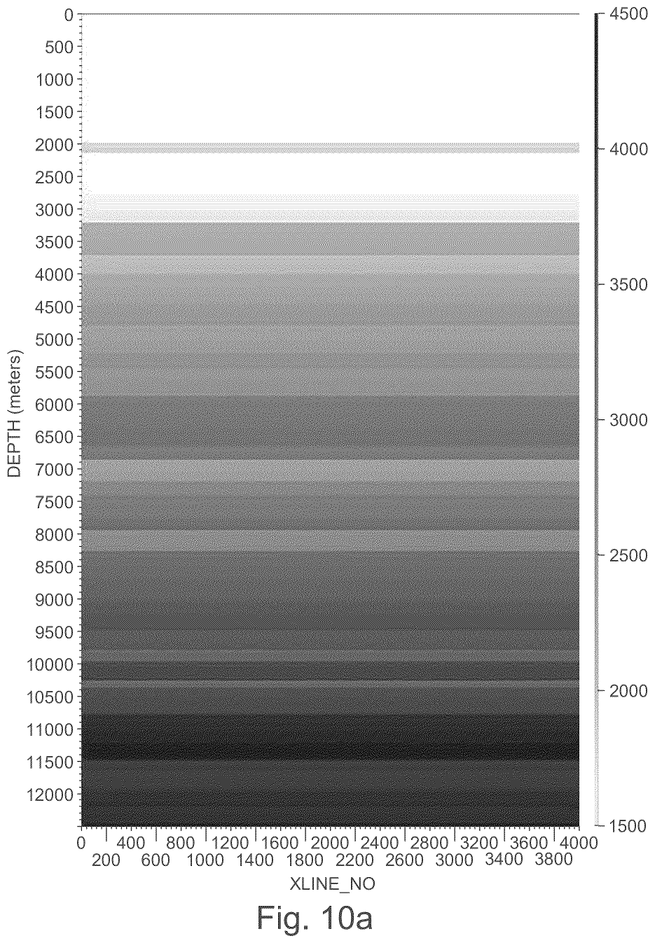

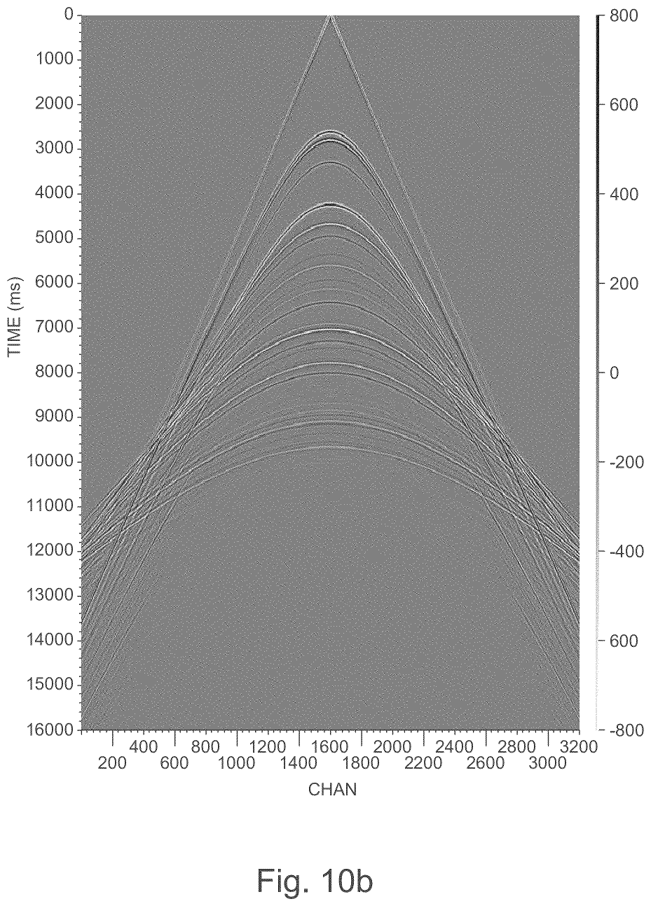

FIG. 9 illustrates a flowchart of a method 900 for seismic processing using the delayed-time shift information to quantify, analyze, or quality control the model system 904 accuracy according to an embodiment. The method 900 may include obtaining field data as at 902, for example, as input. The field data may be acquired from one or more physical seismic acquisition devices, such as geophones, as generally described above. Further, the acquired seismic data may be pre-processed, for instance, to remove noise therefrom, and/or any other suitable processing may be applied. FIG. 10b illustrates simplified synthetic seismic data, as an example of the field data as at 902, generated using the exact p-wave velocity model in FIG. 10a.

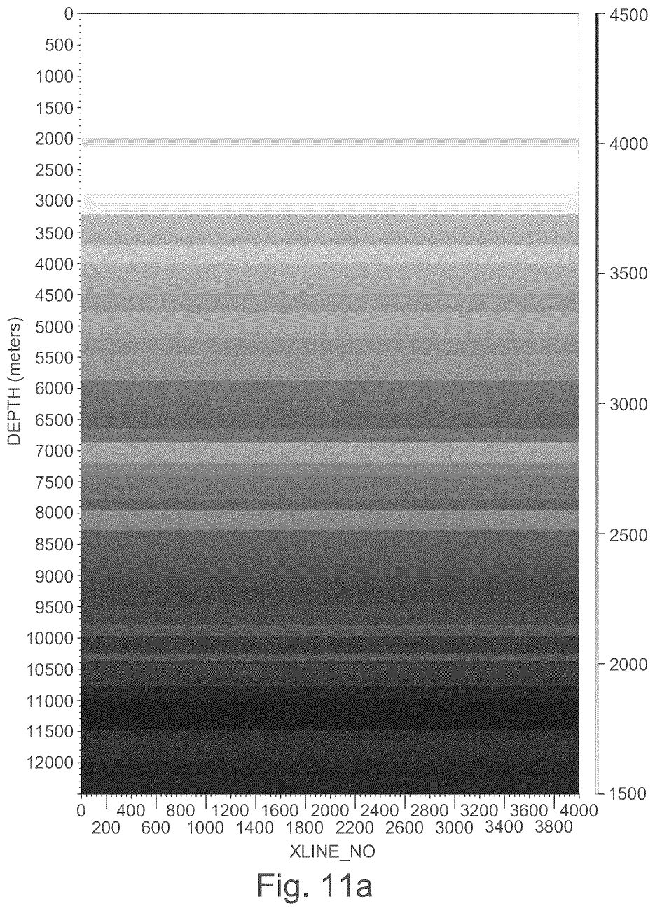

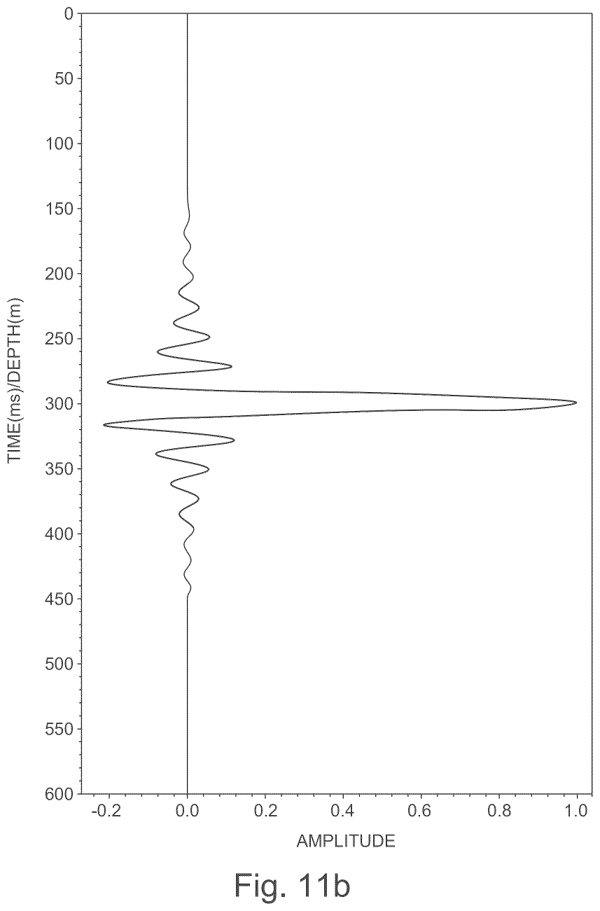

The method 900 may also include a model system of the surveyed formation which helps to describe or simulate waveform or wavefield within the surveyed formation, as at 904, for example, as input. The model system may include but is not limited to p-wave velocity model, s-wave velocity model, anisotropy models, elastic parameters, Q model (to describe subsurface attenuation), density model and etc. Furthermore, the model system may be constructed based on a model of the subterranean formation. For example, the model may be obtained based on any available information about the subterranean formation that is known a priori, before the method 900 is conducted. This may include information about the subterranean formation and general characteristics of the seismic waveforms, etc. FIG. 11a illustrates a simple p-wave velocity model, as an example of the initial model as at 904, which differs from the exact p-wave velocity model in FIG. 10a.

The method 900 may also include obtaining wavelet or data, as at 906, for example, as input. The wavelet may be a result of direct or processed acquisition measurement, analytical or numerical instrument response, or inversion of the instrument response or data matching processing flow. Further, data may be acquired from one or more physical seismic acquisition devices, such as geophones, as generally described above. Further, the acquired seismic data may be pre-processed, for instance, to remove noise therefrom, and/or any other suitable processing may be applied. FIG. 11b illustrates a wavelet profile, as an example of the wavelet as at 906.

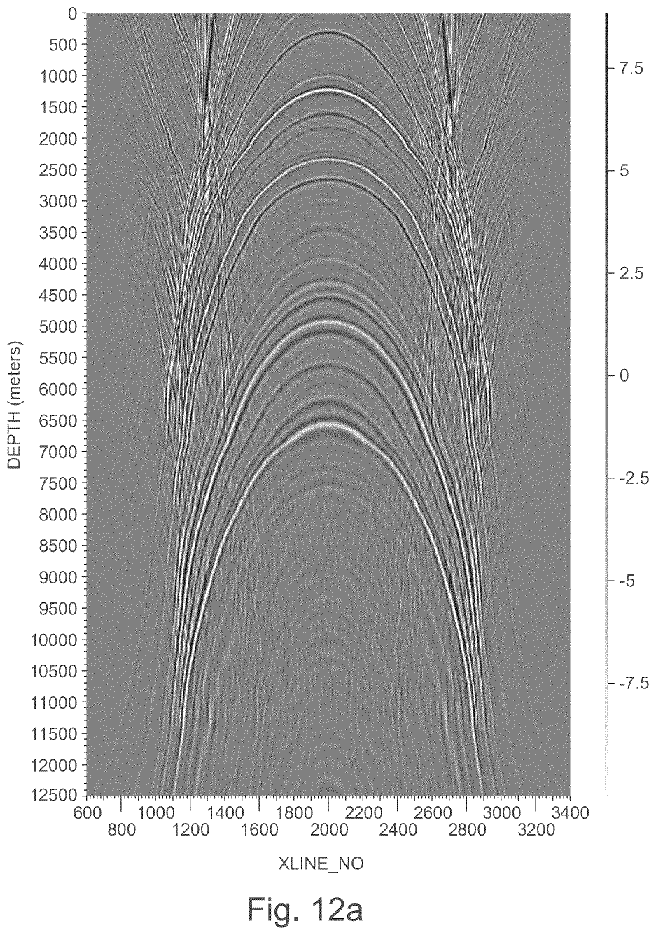

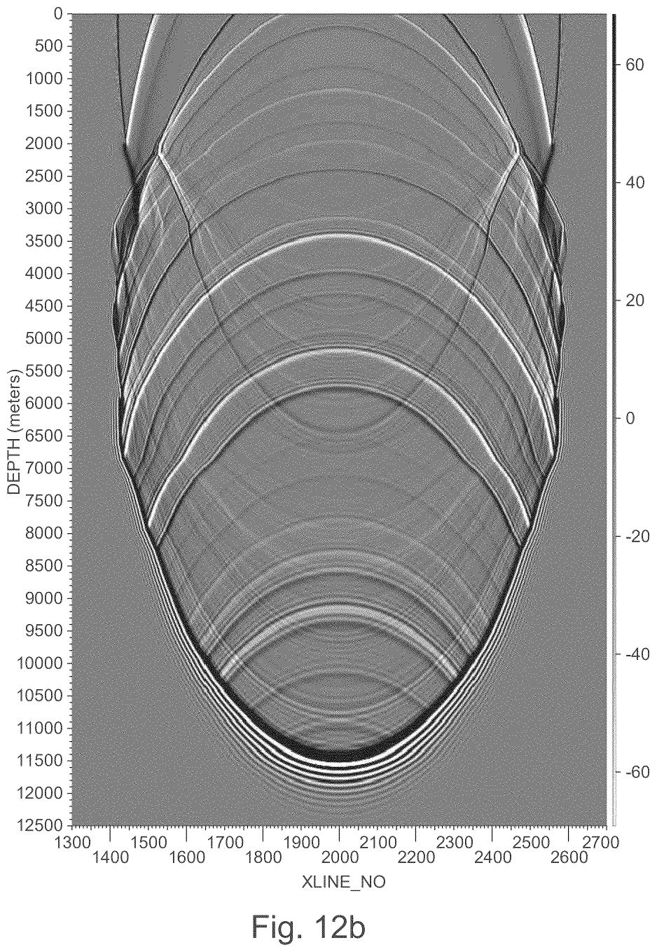

The method 900 may include generating a backward wavefield using the input data 902 and based on the model system 904 by propagating the wavefield backward in time using a suitable wave propagation engine, along with appropriate time initial conditions, spatial boundary conditions, and source terms, as indicated at 908, for example, as backward wavefield simulation. The simplest example of backward wavefield p_{R}(\vec{x};t;\vec{x}ₛ) generation with decreased time may be as follows:

$$\{ \begin{matrix}( \frac{1}{{v ( \vec{x} )}^{2}} \frac{{\partial }^{2}}{\partial {t}^{2}} - {∇}^{2} ) {p}_{R} ( \vec{x} ; t ; {\vec{x}}_{s} ) = 0 , & ( 2 a ) \\ {p}_{R} ( \vec{x} ; t ; {\vec{x}}_{s} ) = δ ( \vec{x} - {\vec{x}}_{r} ) d ( {\vec{x}}_{r} ; t ; {\vec{x}}_{s} ) , & ( 2 b )\end{matrix}$$

where v(\vec{x}) is p-wave velocity. FIG. 12a illustrates an example snap profile of the backward wavefield for the seismic data in FIG. 10b using velocity model in FIG. 11a as at 908.

The method 900 may include generating a forward wavefield using the wavelet or data 906 and based on the model system 904 by propagating the wavefield forward in time using a suitable wave propagation engine, along with appropriate time initial conditions, spatial boundary conditions, and source terms, as indicated at 910, for example, as forward wavefield simulation. The simplest example of forward wavefield p_{S}(\vec{x};t;\vec{x}ₛ) generation with increased time may be as follows:

$$\{ \begin{matrix}( \frac{1}{{v ( \vec{x} )}^{2}} \frac{{\partial }^{2}}{\partial {t}^{2}} - {∇}^{2} ) {p}_{S} ( \vec{x} ; t ; {\vec{x}}_{s} ) = 0 , & ( 3 a ) \\ {p}_{S} ( \vec{x} ; t ; {\vec{x}}_{s} ) = δ ( \vec{x} - {\vec{x}}_{s} ) g ( t ) . & ( 3 b )\end{matrix}$$

FIG. 12b illustrates an example snap profile of the forward wavefield for the wavelet in FIG. 11b using velocity model in FIG. 11a as at 910.

The method 900 may include forming the delayed-time common image gathers (DTCIGs) (Sava, P. and Fomel, S., 2006, “Time-shift imaging condition in seismic migration”: Geophysics, 71, 209-217), as at 912, for example, as gather forming. The DTCIG r(\vec{x};τ) may be generated as follows:

$$r ( \vec{x} ; τ ) = \int \int \int Ψ ( {p}_{S} ) ( \vec{x} ; t - \frac{τ}{2} ; {\vec{x}}_{s} ) Φ ( {p}_{R} ) ( \vec{x} ; t + \frac{τ}{2} ; {\vec{x}}_{s} ) dt d {\vec{x}}_{s} . \qquad ( 4 )$$

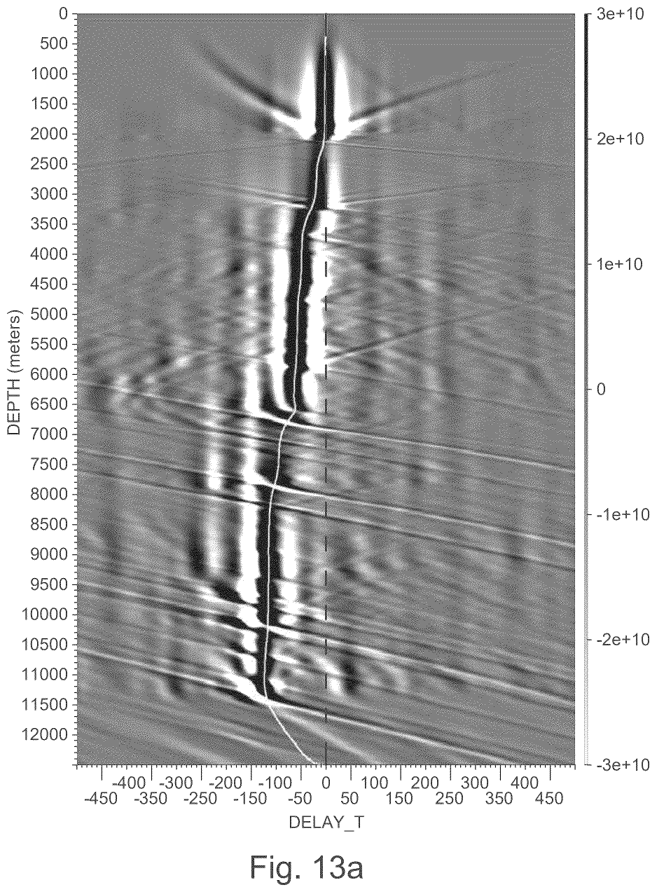

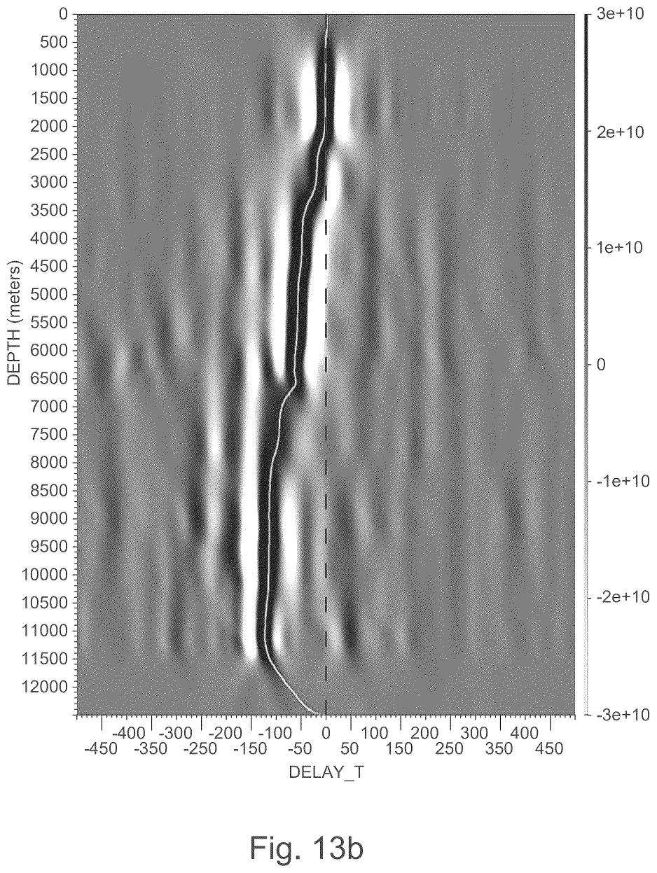

Here, τ is the delayed-time, Ψ and Φ are some proper processing operators applied to the forward and backward wavefields in order to extract desired model information from DTCIGs. FIGS. 13a and 13b illustrate example DTCIG using the raw wavefields and the processed wavefields through the velocity model in FIG. 11a at a typical spatial position of the surveyed formation as at 912, respectively. The white line indicates the picked maximum amplitude along the delayed-time direction for all depths. The dashed line indicates the 0 delayed-time lag.

The method 900 may include virtually, analytically, numerically, or statistically extract model accuracy/error information (such as delayed-time picks, stacks, displays or attributes, etc) from the DTCIGs as at 914, for example, as model accuracy analysis, to measure, analyze, or quality control the model accuracy. As depicted in FIG. 13a, the raw DTCIG contains two distinct types of seismic events: (1) vertically prominent events generated by diving waves due to velocity variations and the reflections induced by model interfaces, and (2) slanted events resulting from seismic reflection imaging. Method 900 leverages only the first type of events from DTCIGs for accuracy measurement, analysis or quality control purpose. FIG. 13b shows that various signal processing techniques, such as slant stacking, tau-p transform and FK filtering, can be applied to the raw DTCIG from FIG. 13a to eliminate the second type of events. The processed DTCIG, as illustrated in FIG. 13b, offers a more straightforward input for measuring, analysing, or quality controlling the model accuracy.

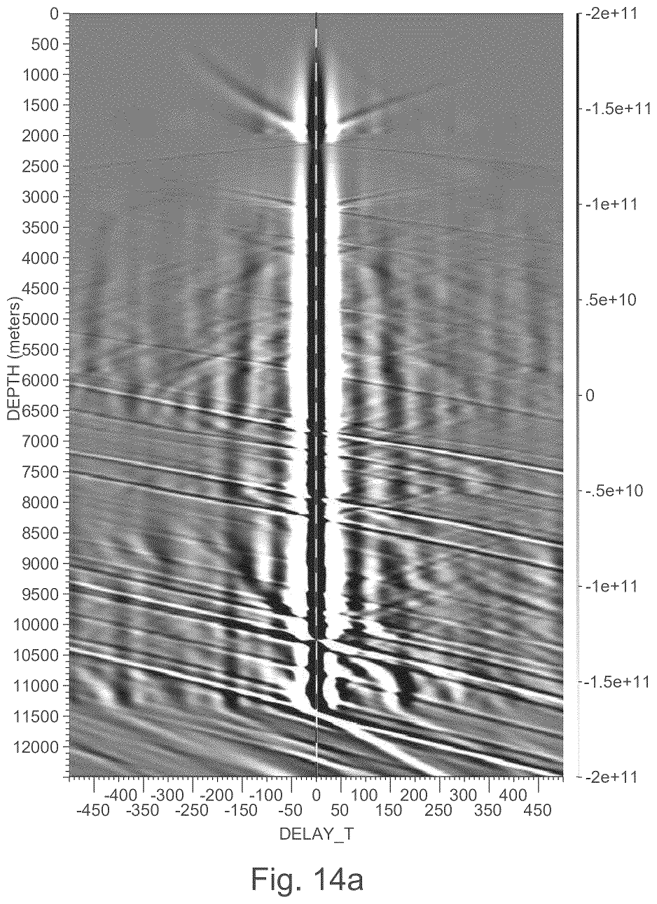

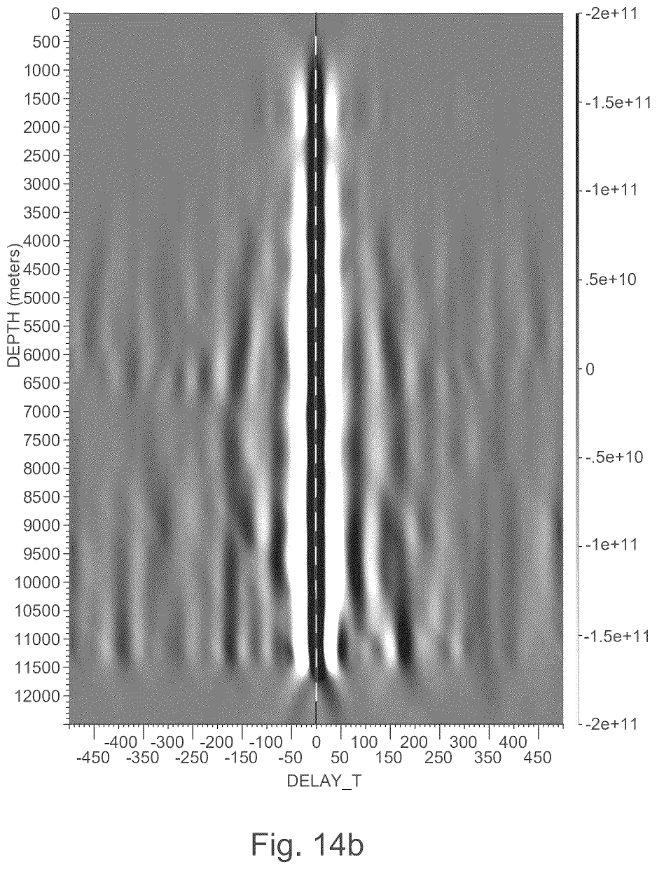

FIGS. 14a and 14b illustrates example DTCIG using the raw wavefields and the processed wavefields through the exact model system in FIG. 10a at the same spatial position of the surveyed formation as in FIG. 13, respectively. The white line indicates the picked maximum amplitude along the delayed-time direction for all depths. The dashed line indicates the 0 delayed-time lag. For the correct velocity, the diving waves in the forward and backward wavefields meet along the ray path at the correct timing; their energy thus focuses at zero-lag (r=0) delayed-time on the DTCIG as indicated by the dashed line in FIG. 14. On the other hand, the incorrect initial model results in the diving waves to defocus as well as to be carried away from the correct timing, as indicated by the zero-lag delay time using dashed line on the DTCIG in FIG. 13. The velocity accuracy/error can thus be quantified and analysed on the DTCIGs through the focusing of the diving waves and their deviation from the zero-lag delay time. Similar analysis can be applied to the vertically prominent events (the first type of events introduced in [00071]) which are generated by reflections from impedance interfaces during wave propagation.

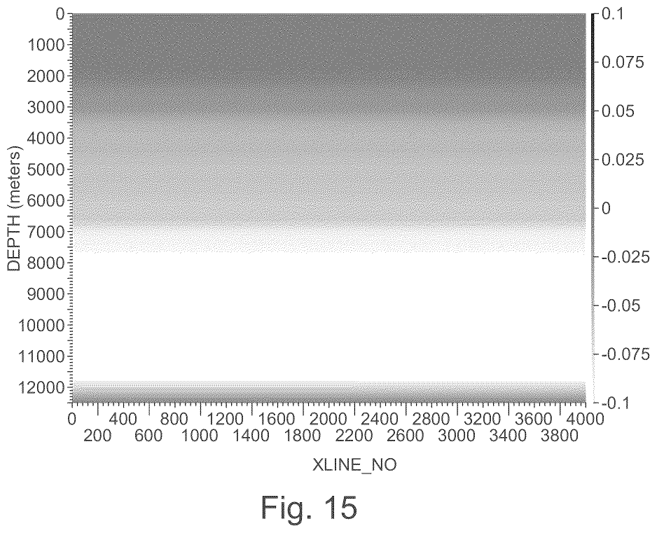

As a result, a simple example of the extraction process as at 914, is the delayed-time picks as shown by the white line in FIGS. 13 and 14. FIG. 15 displays the delayed-time picking value at all the spatial locations of the surveyed formation, as illustrated in the DTCIGs in FIG. 13. The delayed-time picking value in FIG. 15 will thus provide model accuracy/error information.

For completeness, a flowchart of a method 900 for seismic processing using the delayed-time shift information to quantify, analyze, or quality control the model system 904 accuracy according to an embodiment is illustrated using the 3D SEG Advanced Modeling (SEAM) model (Fehler, M. and K. Larner, 2008, “SEG Advanced Modeling (SEAM): Phase I first year update”: The Leading Edge 27: 1006-1007).

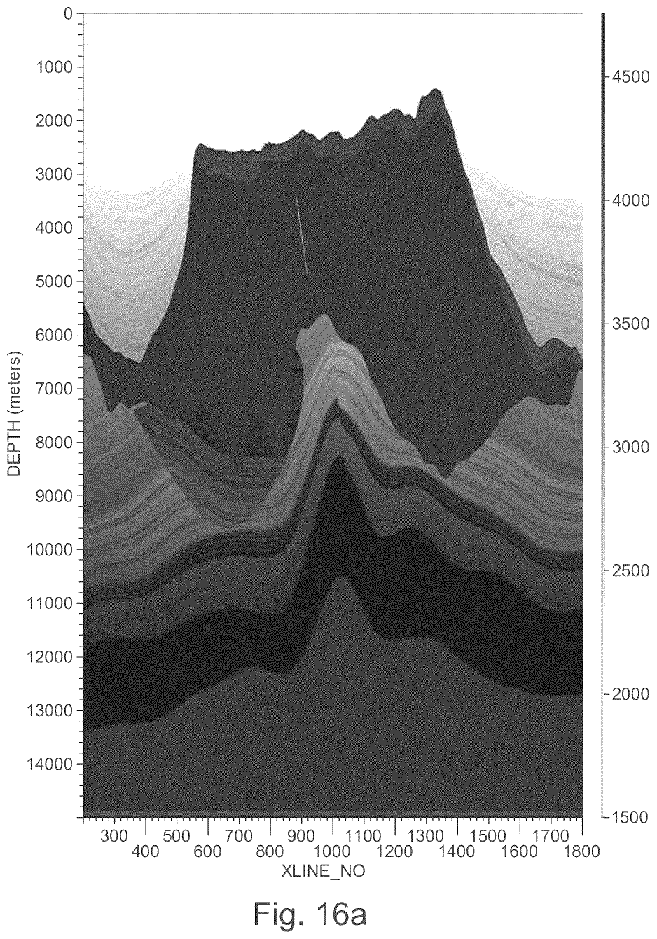

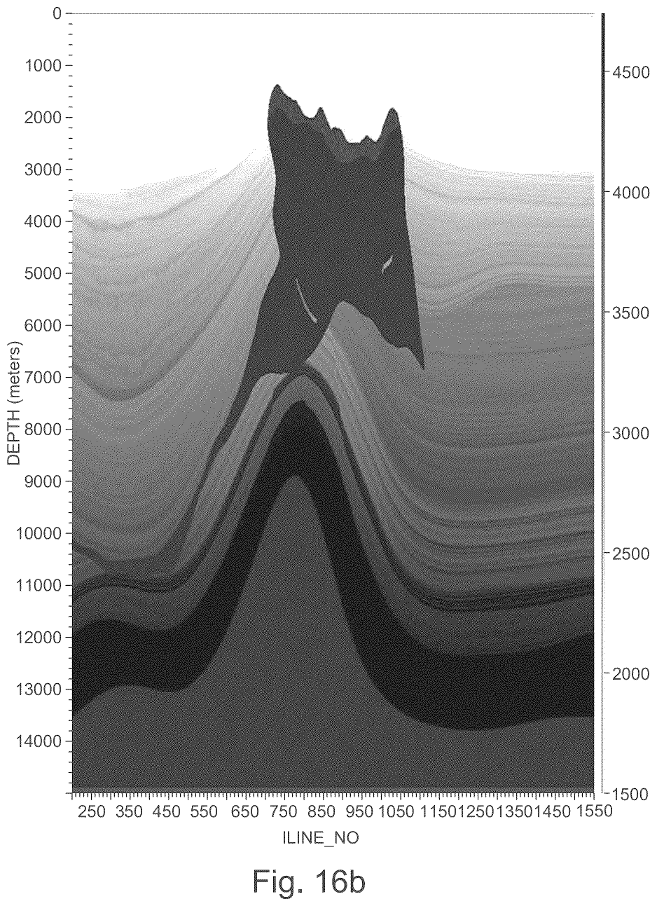

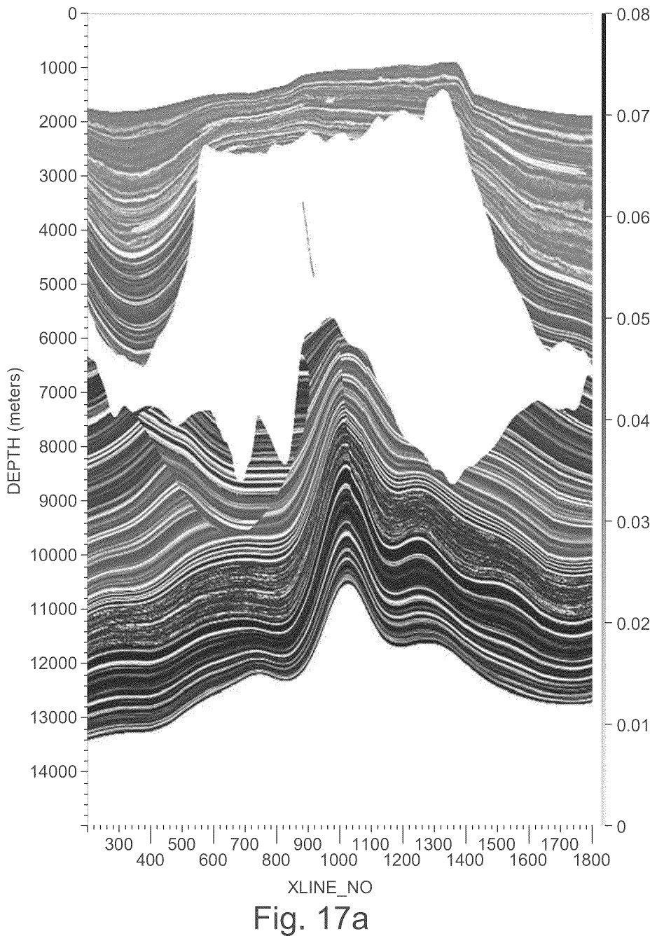

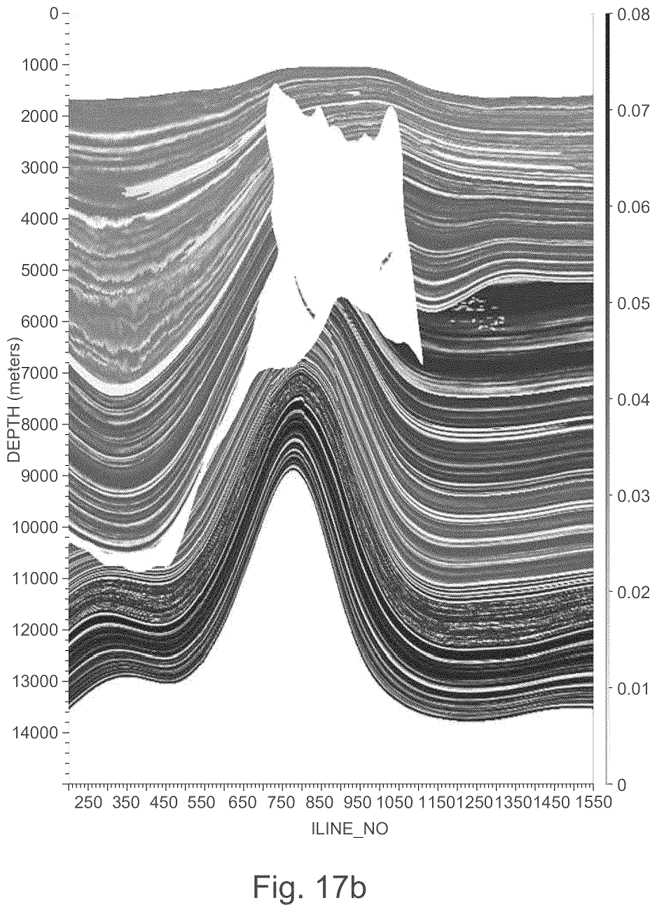

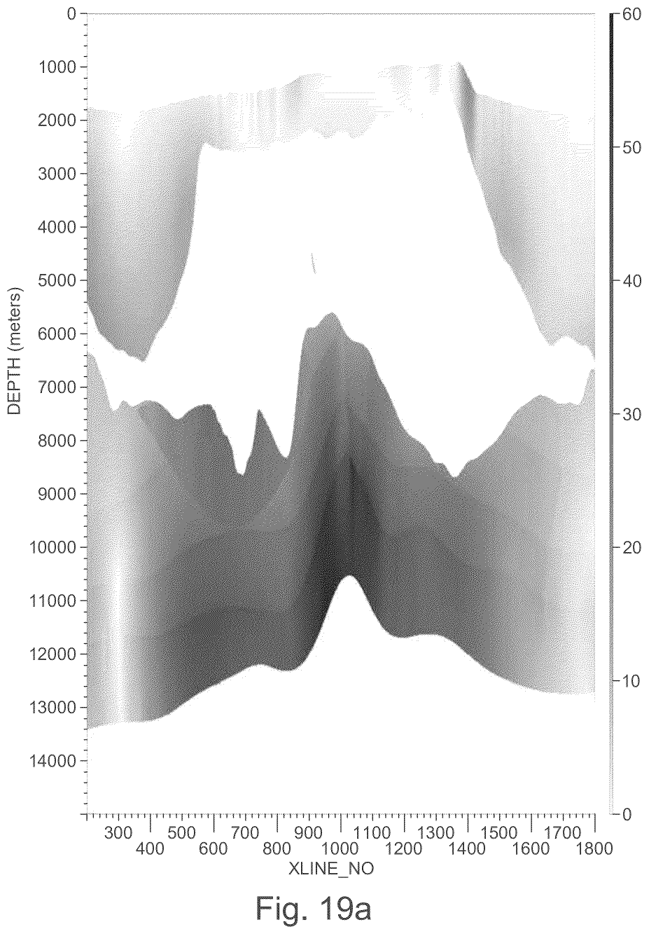

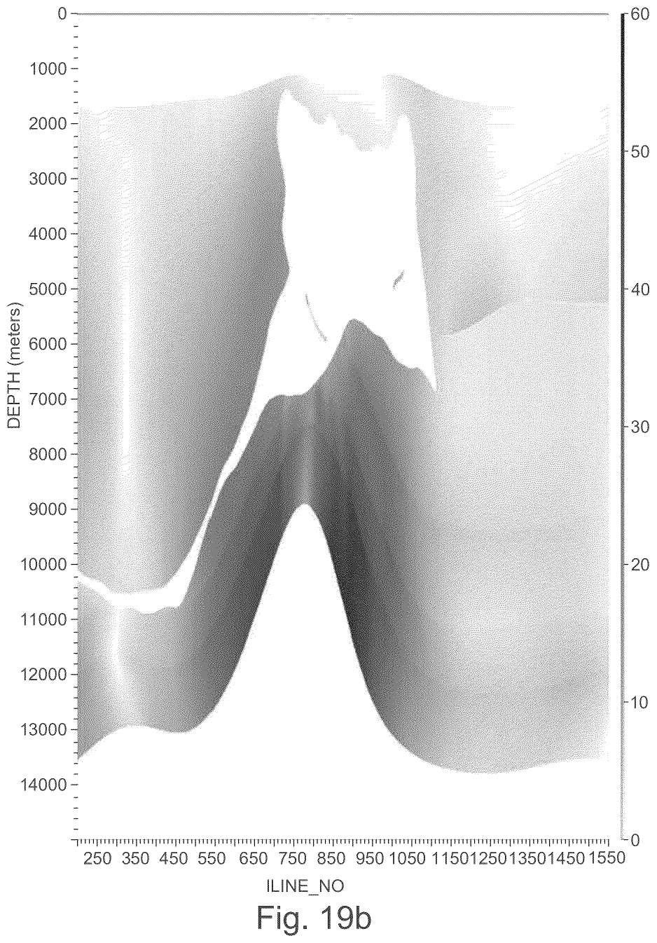

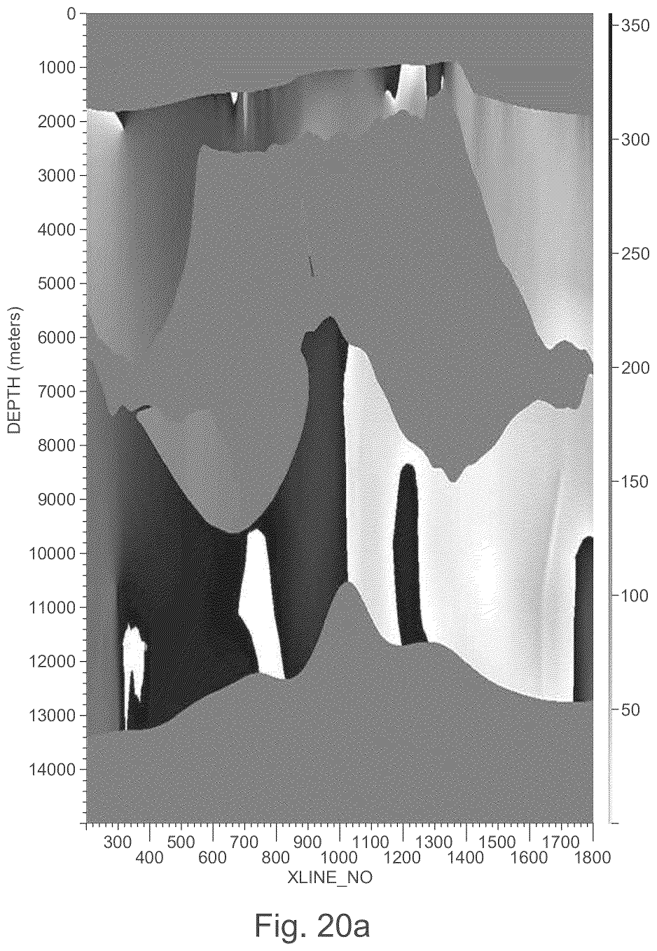

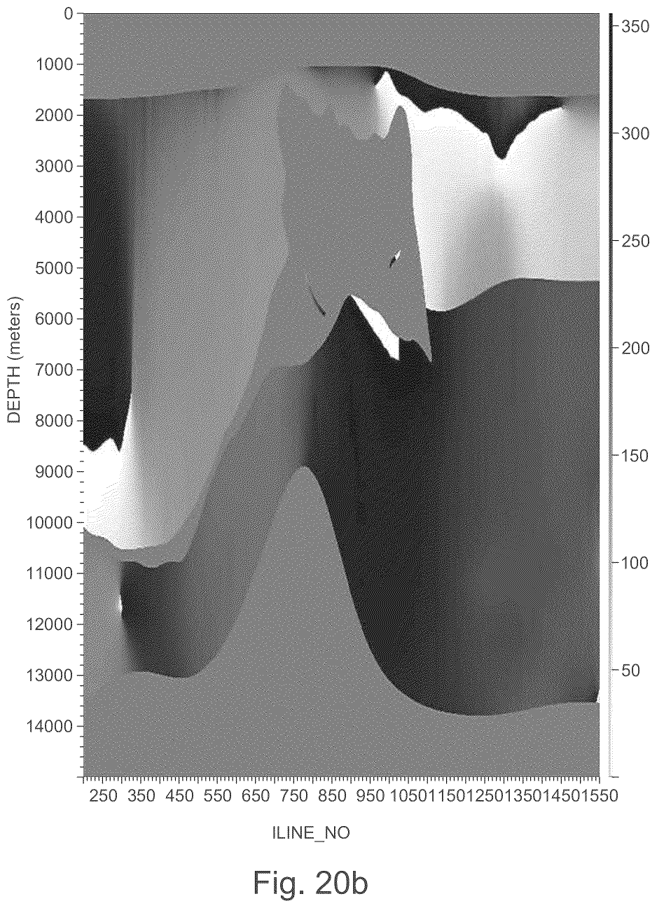

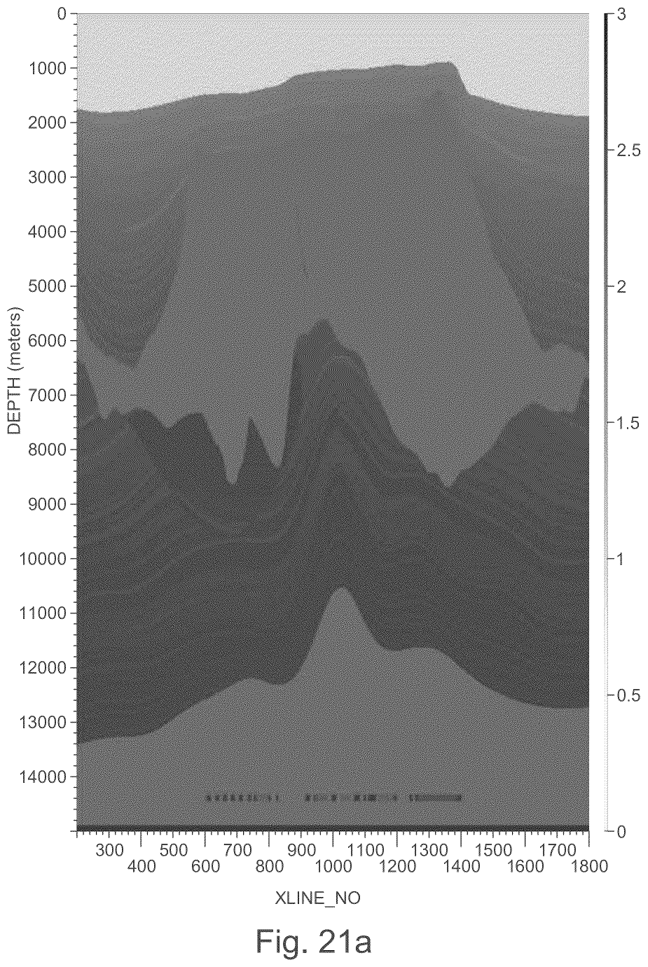

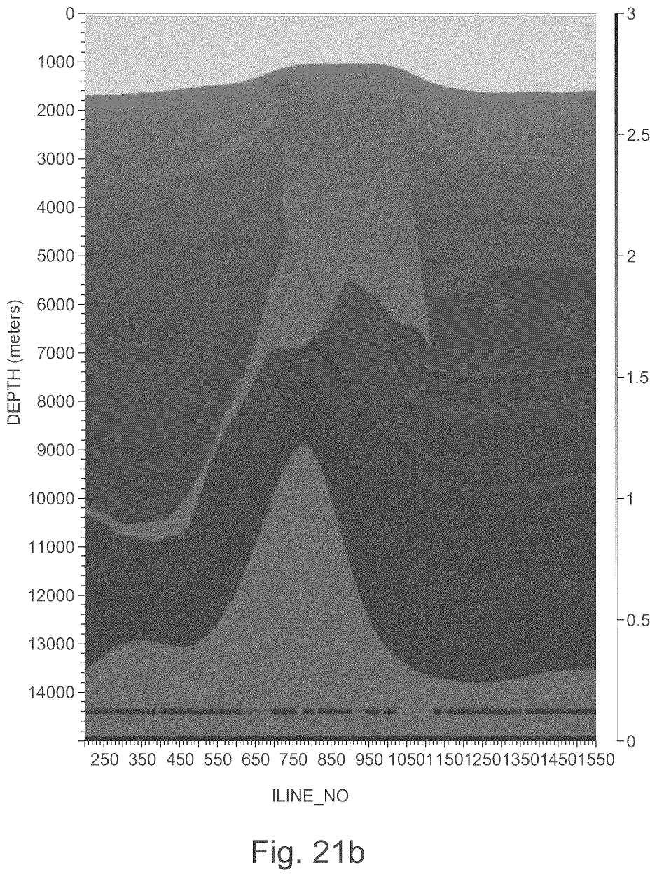

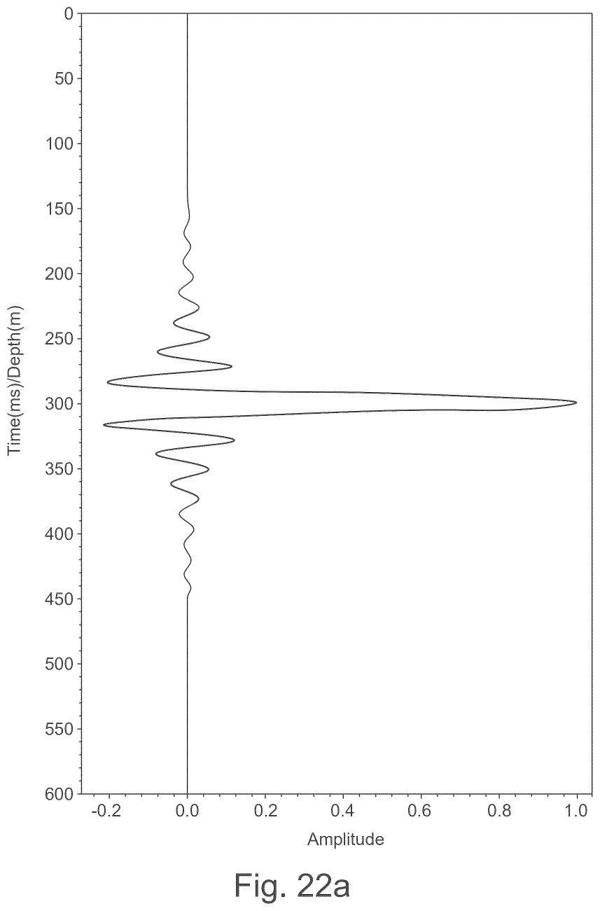

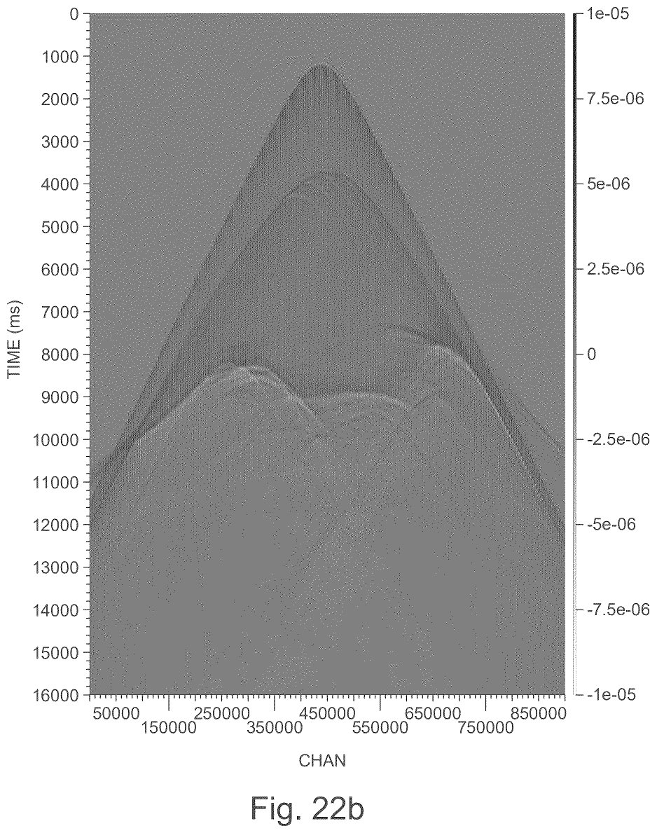

The method 900 may include obtaining field data as at 902, for example, as input. The field data may be acquired from one or more physical seismic acquisition devices, such as geophones, as generally described above. Further, the acquired seismic data may be pre-processed, for instance, to remove noise therefrom, and/or any other suitable processing may be applied. FIG. 22b illustrates simplified synthetic seismic data, as an example of the field data as at 902, generated using the source wavelet in FIG. 22a and the exact p-wave, anisotropic Thomsen parameter δ, ε, dip, azimuth and density models in FIGS. 16, 17, 18, 19, 20 and 21, respectively.

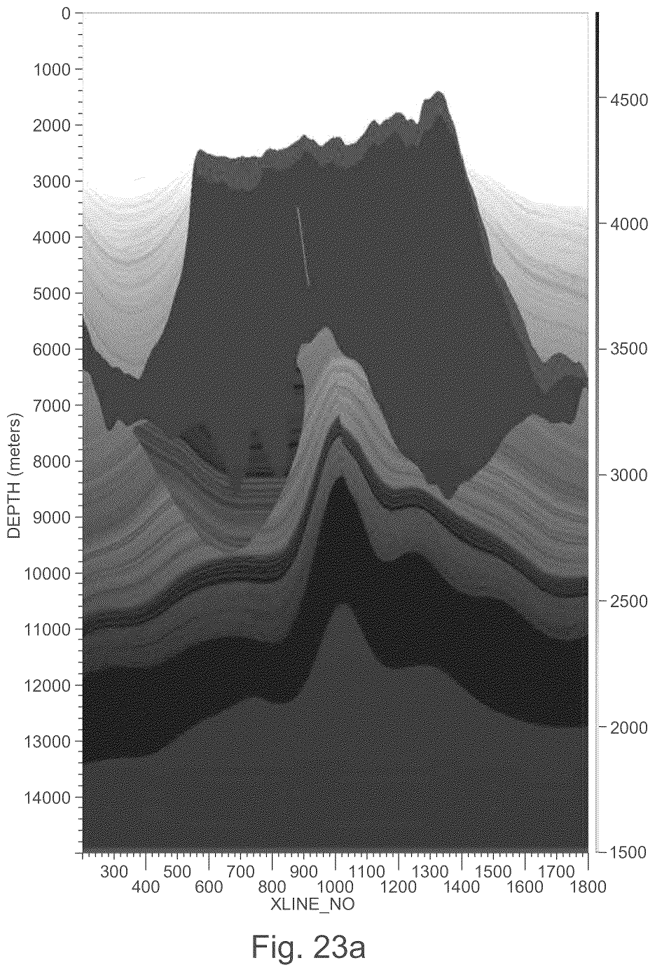

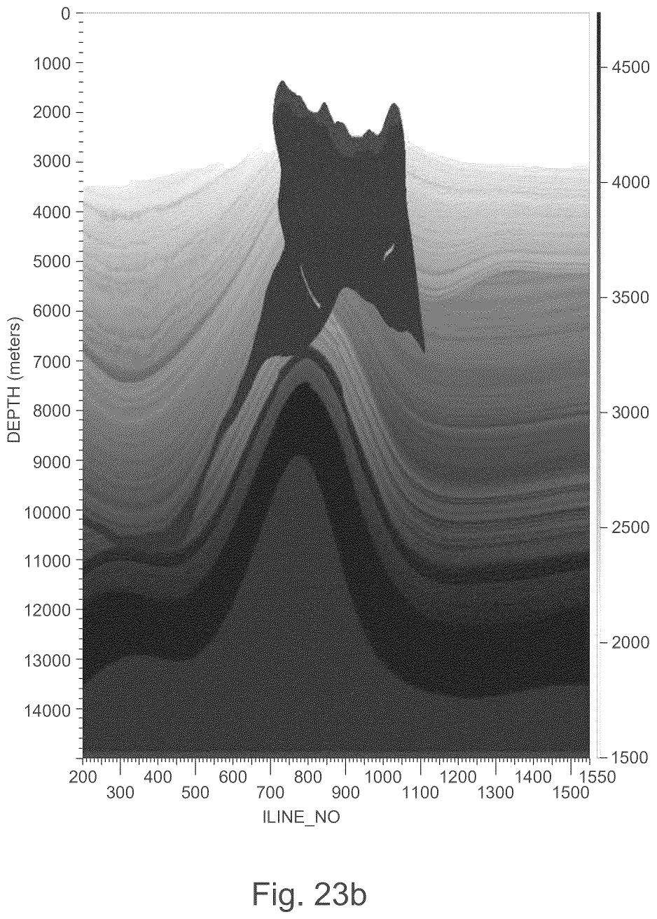

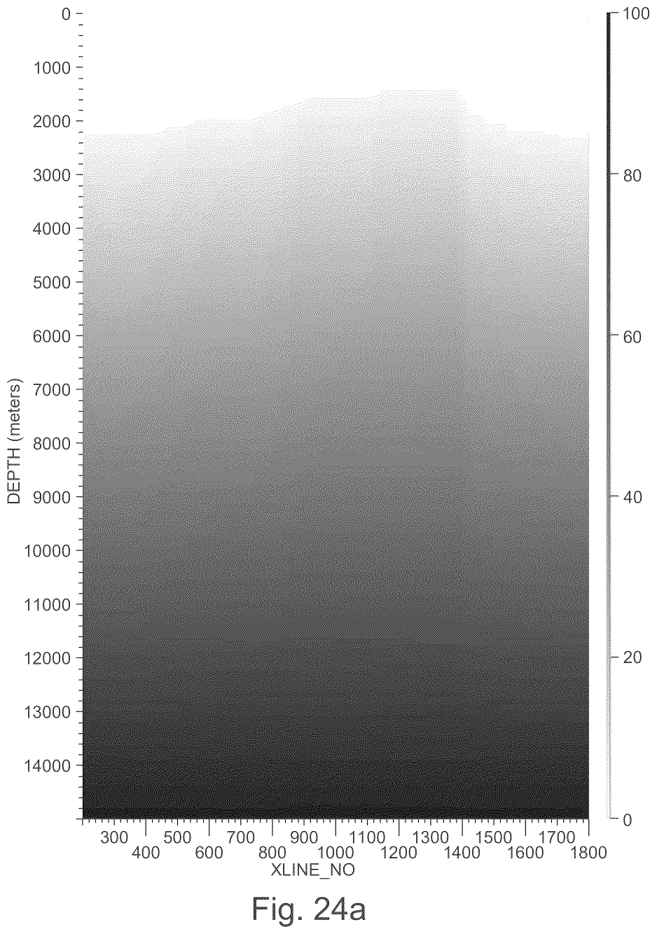

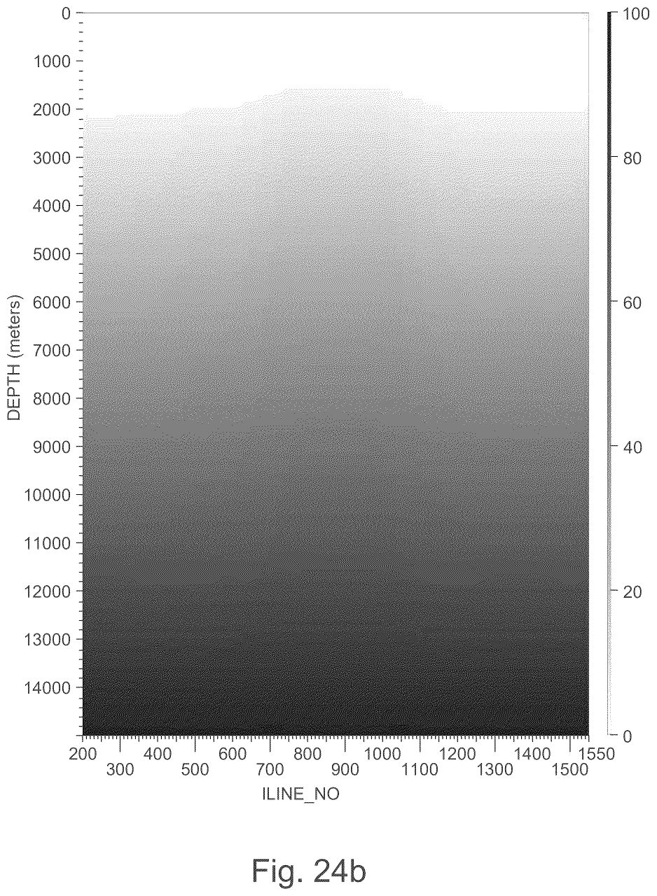

The method 900 may also include a model system of the surveyed formation which helps to describe or simulate waveform or wavefield within the surveyed formation, as at 904, for example, as input. The model system may include but is not limited to p-wave velocity model, s-wave velocity model, anisotropy models, elastic parameters, Q model (to describe subsurface attenuation), density model and etc. Furthermore, the model system may be constructed based on a model of the subterranean formation. For example, the model may be obtained based on any available information about the subterranean formation that is known a priori, before the method 900 is conducted. This may include information about the subterranean formation and general characteristics of the seismic waveforms, etc. FIG. 23 illustrates a simple p-wave velocity model, as an example of the initial model as at 904, which differs from the exact p-wave velocity model in FIG. 16. Their difference is illustrated in FIG. 24.

The method 900 may also include obtaining wavelet or data, as at 906, for example, as input. The wavelet may be a result of direct or processed acquisition measurement, analytical or numerical instrument response, or inversion of the instrument response or data matching processing flow. Further, data may be acquired from one or more physical seismic acquisition devices, such as geophones, as generally described above. Further, the acquired seismic data may be pre-processed, for instance, to remove noise therefrom, and/or any other suitable processing may be applied. FIG. 22a illustrates a wavelet profile, as an example of the wavelet as at 906.

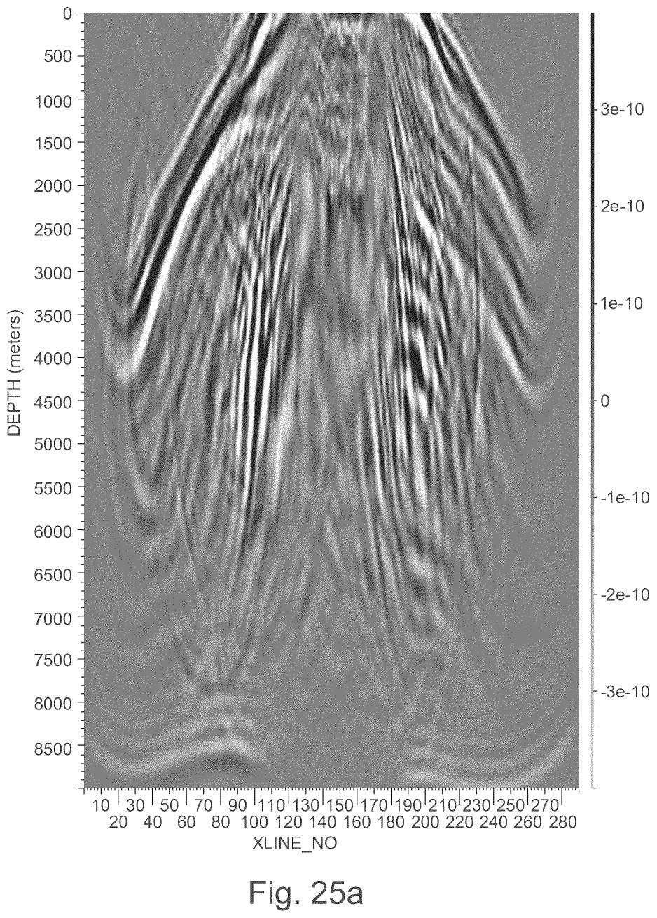

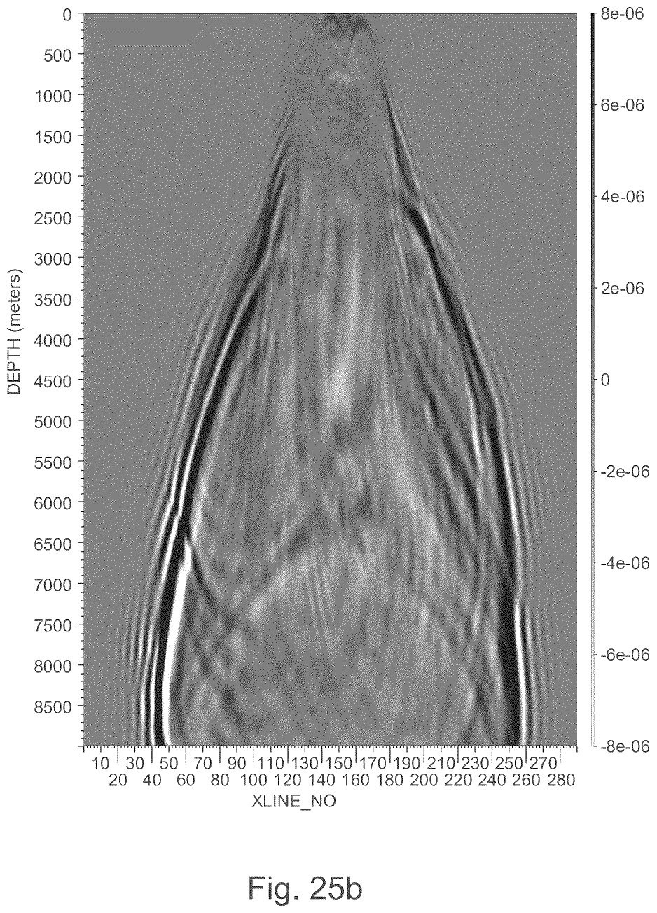

The method 900 may include generating a wavefield using the input data 902 and based on the model system 904 by propagating the wavefield backward in time using a suitable wave propagation engine, along with appropriate time initial conditions, spatial boundary conditions, and source terms, as indicated at 908, for example, as backward wavefield simulation. The simplest example of backward waveform generation is to solve equations (2) and store p_{R}(\vec{x};t;\vec{x}ₛ). FIG. 25a illustrates an example snap profile of the backward wavefield for the seismic data in FIG. 22b using velocity model in FIG. 23 as at 908.

The method 900 may include generating a wavefield using the wavelet or data 906 and based on the model system 904 by propagating the wavefield forward in time using a suitable wave propagation engine, along with appropriate time initial conditions, spatial boundary conditions, and source terms, as indicated at 910, for example, as forward wavefield simulation. The simplest example of forward waveform generation is to solve equation (3) and store p_{S}(\vec{x};t;\vec{x}ₛ). FIG. 25b illustrates an example snap profile of the forward wavefield for the wavelet in FIG. 22a using velocity model in FIG. 23 as at 910.

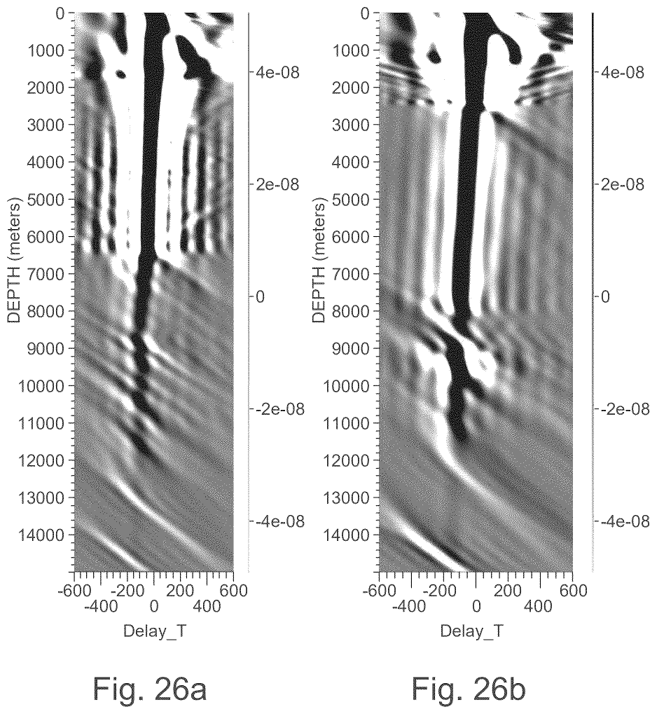

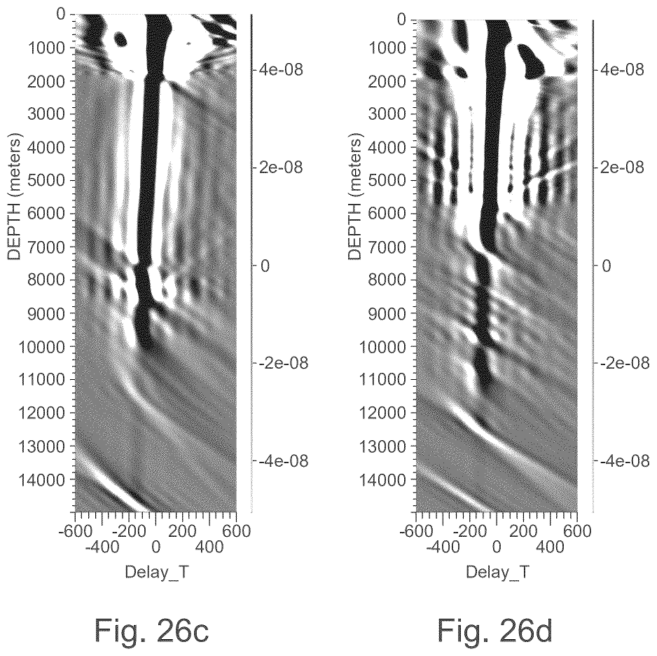

The method 900 may include forming the delayed-time common image gathers (DTCIGs) (Sava, P. and Fomel, S., 2006, “Time-shift imaging condition in seismic migration”: Geophysics, 71, 209-217), as at 912, for example, as gather forming. The DTCIG r(\vec{x};τ) may be generated using equation (4). FIG. 26 illustrates example DTCIG using the raw wavefields and the processed wavefields through the velocity model in FIG. 23 at typical spatial positions of the surveyed formation as at 912, respectively. The white line indicates the picked maximum amplitude along the delayed-time direction for all depths. The dashed line indicates the 0 delayed-time lag.

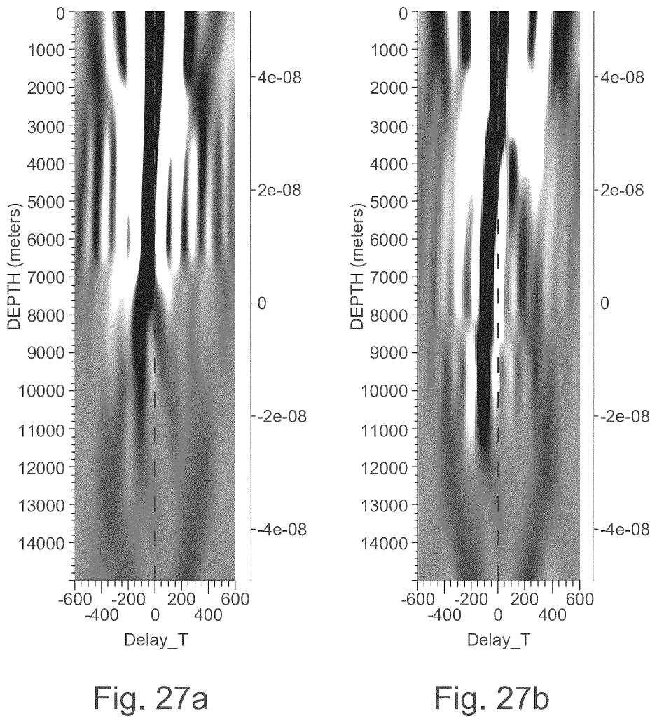

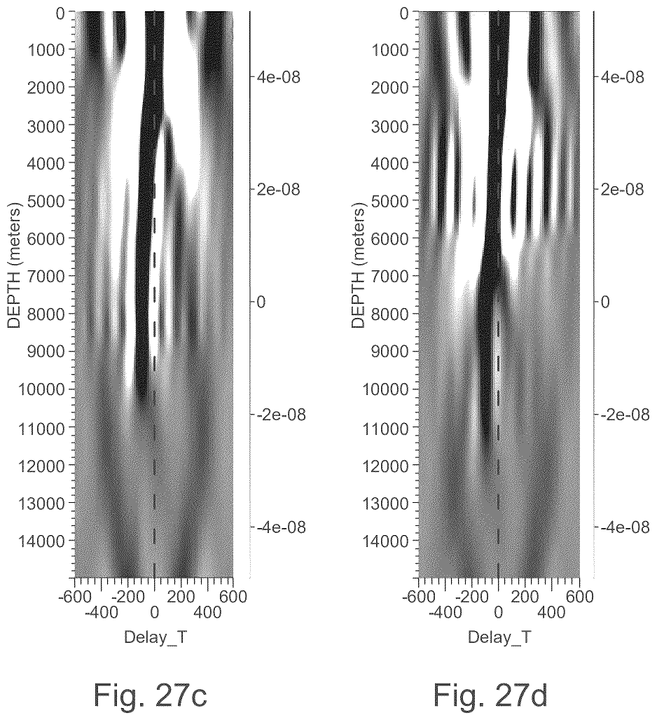

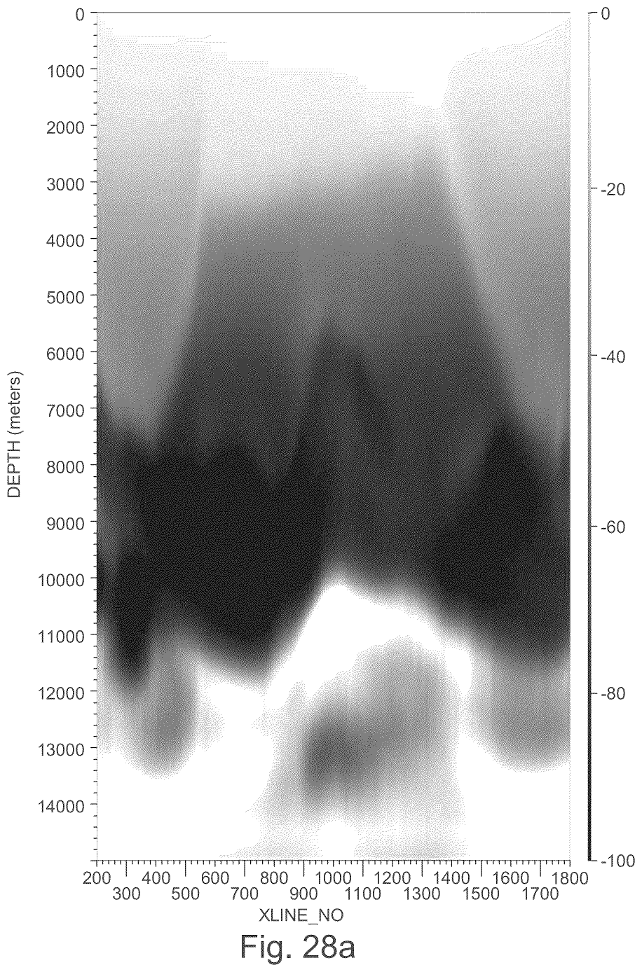

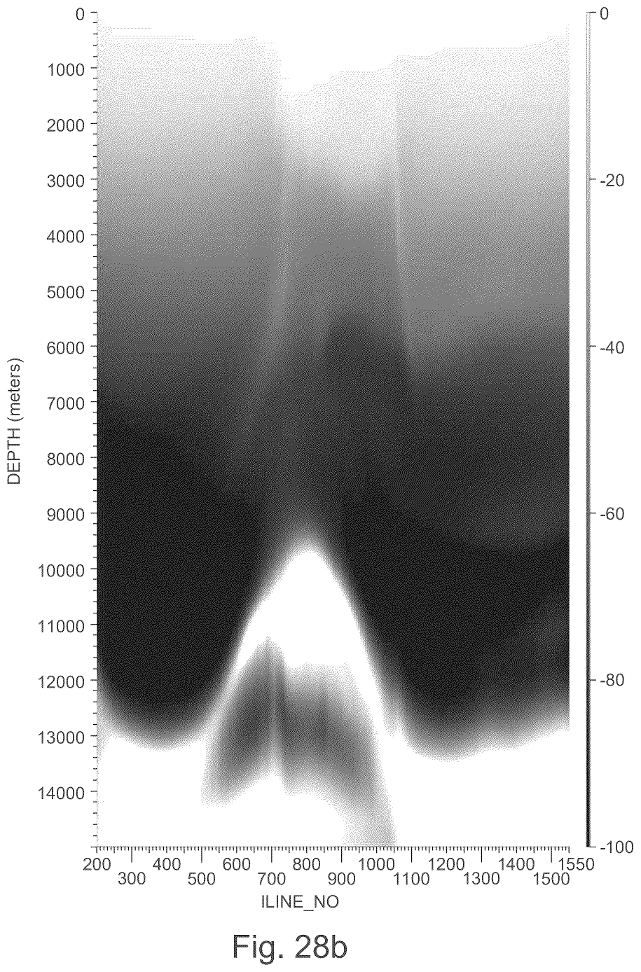

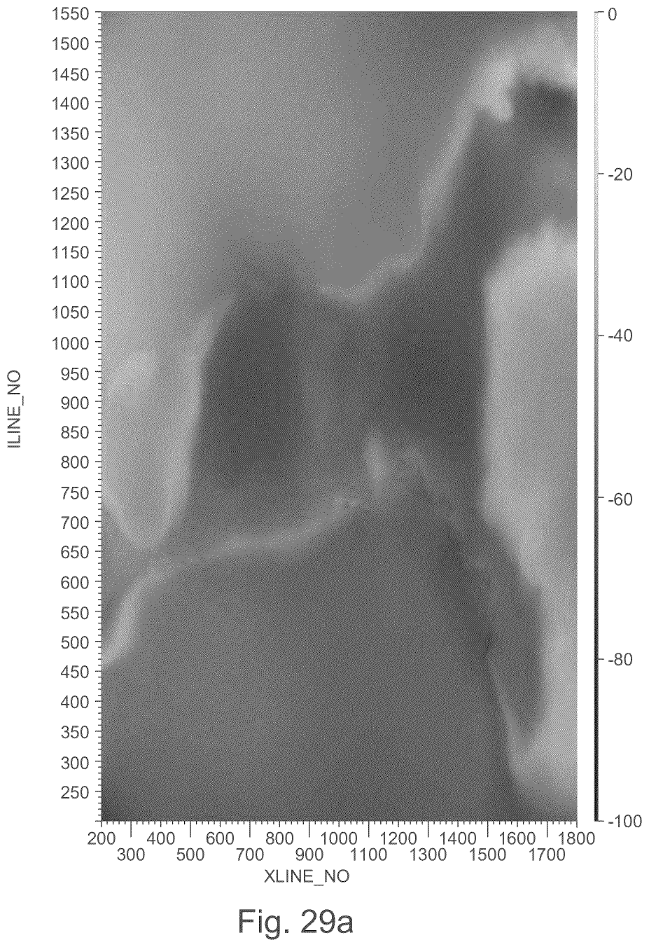

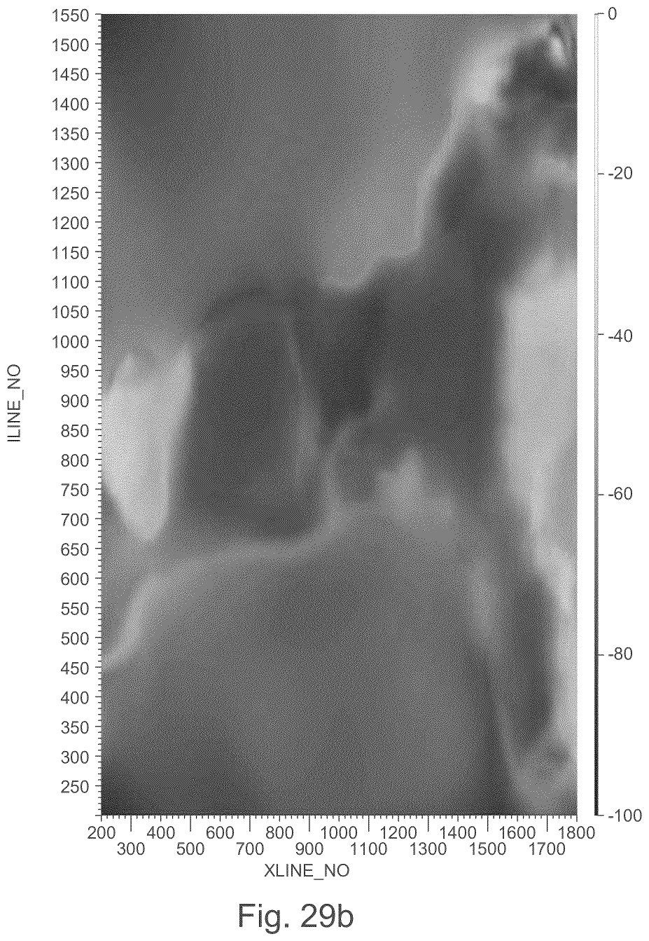

The method 900 may include virtually, analytically, numerically, or statistically extract model accuracy/error information (such as delayed-time picks, stacks, displays or attributes, etc) from the DTCIGs as at 914, for example, as model accuracy analysis, to measure, analyze, or quality control the model accuracy. FIGS. 28. and 29. summaries the descried model accuracy/error attribute in a three-dimensional space in addition to the two-dimensional space illustration in FIG. 15. Displaying the delay time value with the maximum amplitude picks on the DTCIG in FIG. 27 at every spatial three-dimensional location, FIG. 28 and FIG. 29 demonstrates the delay-time deviate from the ideal 0 delayed-time lag. A close inspection shows that the linear velocity perturbation from shallow to deep as in FIG. 24 matches with the accuracy/error attribute in FIGS. 28 and 29. Due to the lack of wave penetration and delay time gather focusing, an uncertainty boundary, below which the velocity accuracy/error attribute is no longer accurate, can also be extracted as illustrated in FIG. 28.

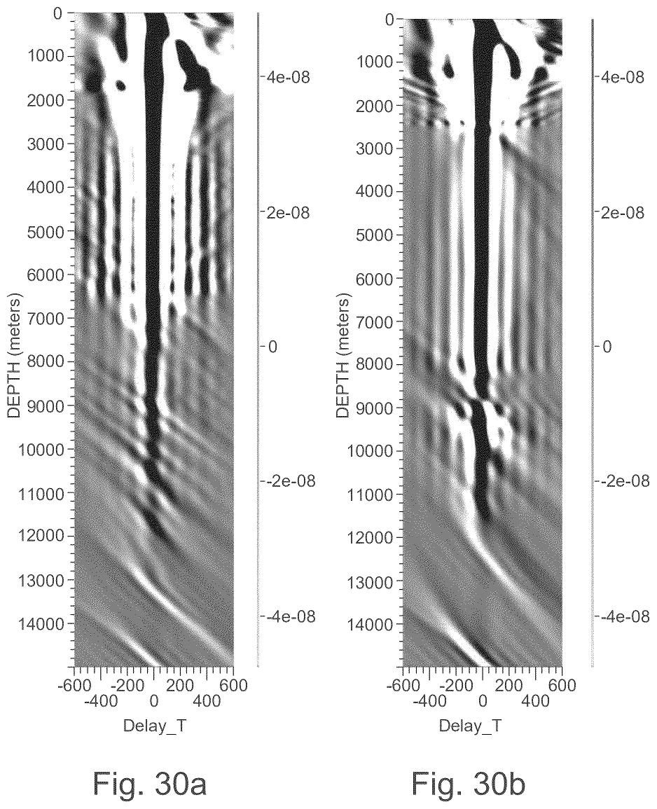

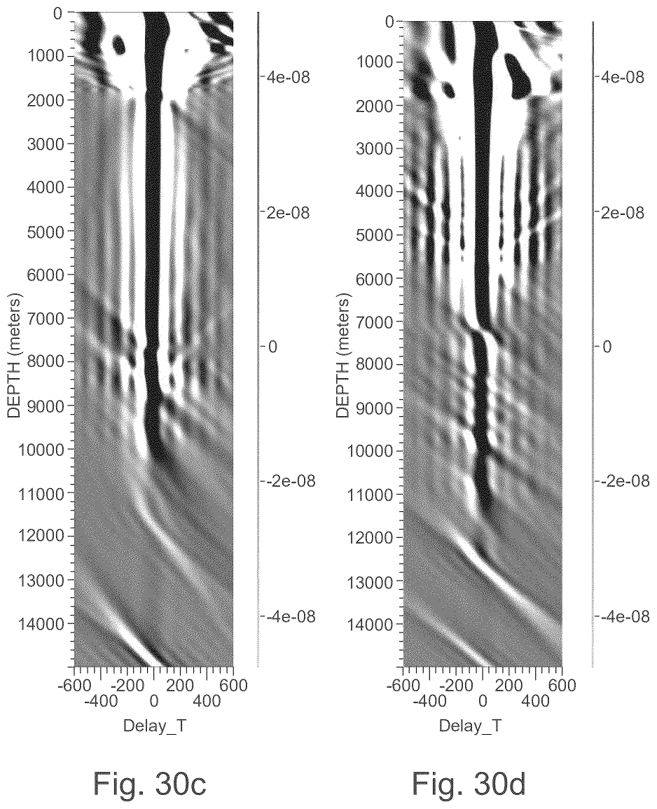

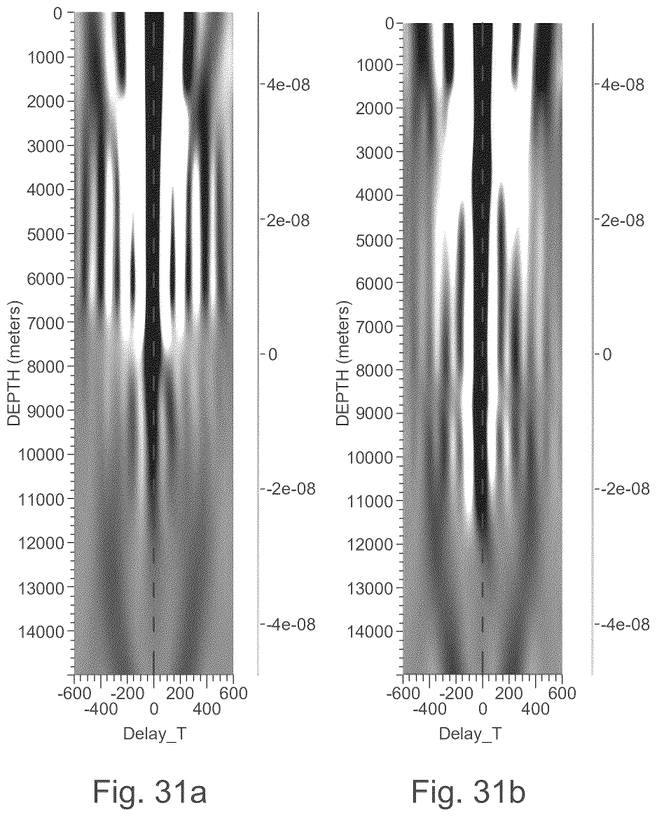

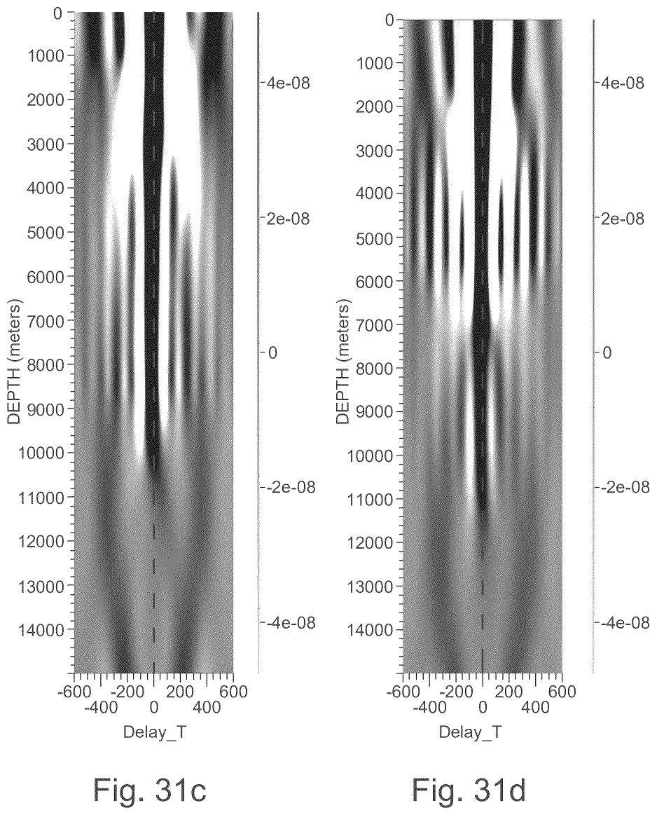

In contrast, FIGS. 30 and 31 illustrates example DTCIG using the raw wavefields and the processed wavefields through the exact model system in FIG. 16a at the same spatial position of the surveyed formation as in FIGS. 26 and 27, respectively. The white line indicates the picked maximum amplitude along the delayed-time direction for all depths. The dashed line indicates the 0 delayed-time lag. For the correct velocity, the diving waves in the forward and backward wavefields meet along the ray path at the correct timing; their energy thus focuses at zero-lag (τ=0) delayed-time on the DTCIG as indicated by the dashed line in FIG. 31. On the other hand, the incorrect initial model results in the diving waves to defocus as well as to be carried away from the correct timing, as indicated by the zero-lag delay time using dashed line on the DTCIG in FIG. 27. The velocity accuracy/error can thus be quantified and analysed on the DTCIGs through the focusing of the diving waves and their deviation from the zero-lag delay time.

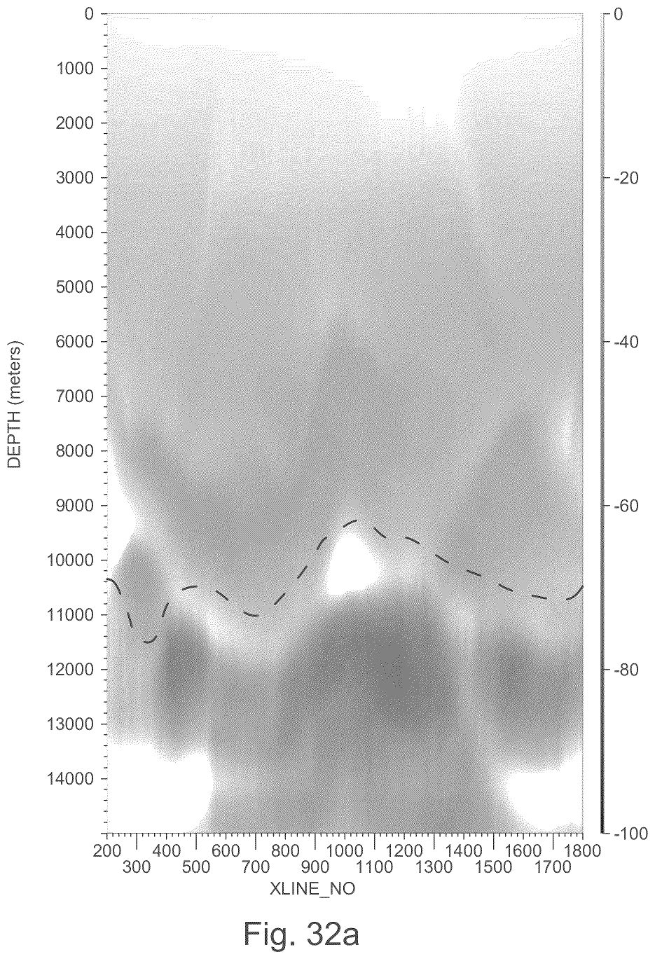

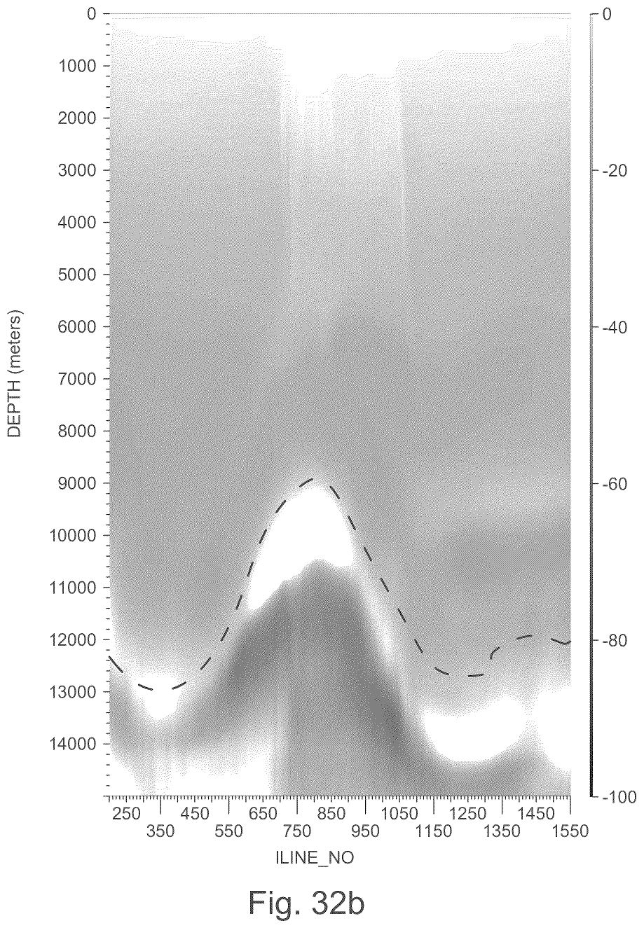

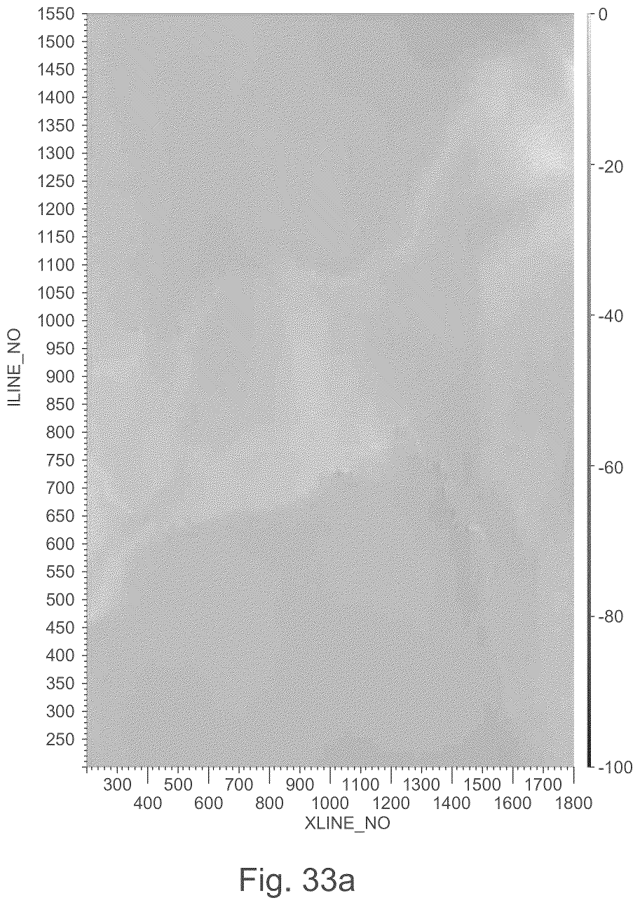

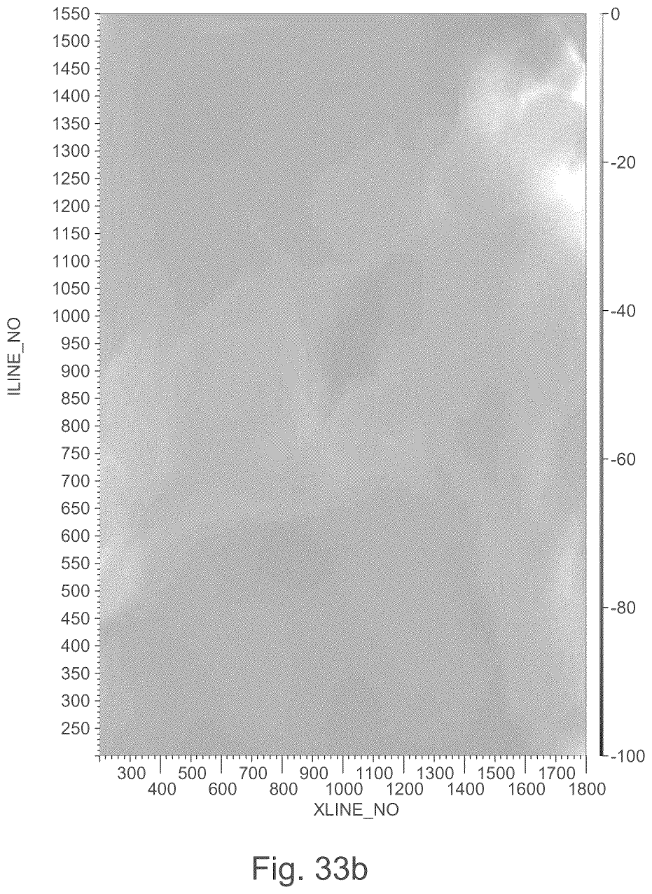

Displaying the delay time value with the maximum amplitude picks on the DTCIG in FIG. 31 at every spatial three-dimensional location as in FIGS. 28 and 29, FIG. 32 and FIG. 33 demonstrates the velocity accuracy/error attribute. Above the uncertainty boundary indicated by the gray line, the velocity accuracy/error attribute illustrates values close to the ideal 0 delayed-time lag. It thus provides the quantitative measurement that the velocity is correct.

As a result, a simple example of the extraction process as at 914, is the delayed-time picks as shown by the white line in FIGS. 27 and 31. FIGS. 28, 29, 32 and 33 display the delayed-time picking value at all the spatial locations of the surveyed formation, as illustrated in the DTCIGs in FIGS. 27 and 31. The delayed-time picking value in FIGS. 28, 29, 32 and 33 will thus provide model accuracy/error information.

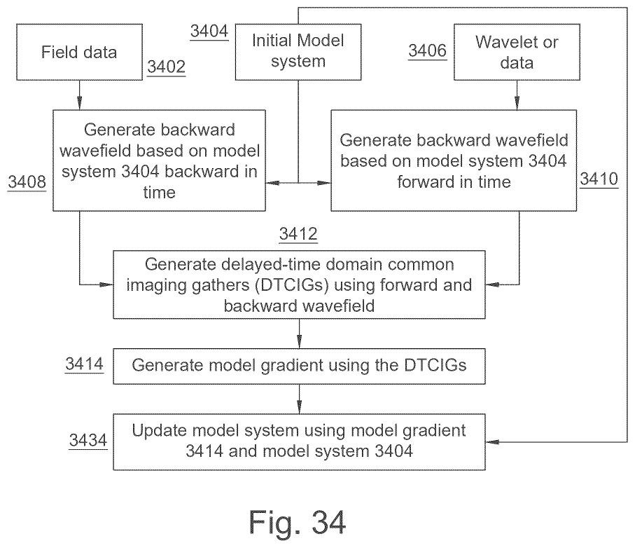

FIG. 34 illustrates a flowchart of a method 3400 for seismic processing using the delayed-time shift information to update the model system 3404 according to an embodiment. The method 3400 may include obtaining field data as at 3402, for example, as input. The field data may be acquired from one or more physical seismic acquisition devices, such as geophones, as generally described above. Further, the acquired seismic data may be pre-processed, for example, to remove noise therefrom, and/or any other suitable processing may be applied. FIG. 10b illustrates simplified synthetic seismic data, as an example of the field data as at 3402, generated using the exact p-wave velocity model in FIG. 10a.

The method 3400 may also include an initial model system of the surveyed formation which helps to describe or simulate waveforms or wavefields within the surveyed formation, as at 3404, for example, as input. The model system may include but is not limited to p-wave velocity model, s-wave velocity model, anisotropy models, elastic parameters, Q model (to describe subsurface attenuation), density model and so on. Further, the model system may be constructed based on a model of the subterranean formation. For example, the model system may be obtained based on any available information about the subterranean formation that is known a priori, before the method 3400 is conducted. This may include information about the subterranean formation, general characteristics of the seismic waveforms, etc. FIG. 11a illustrates a simple p-wave velocity model, as an example of the initial model as at 3404, which differs from the exact p-wave velocity model in FIG. 10a.

The method 3400 may also include obtaining wavelet or data, as at 3406, for example, as input. The wavelet may be a result of direct or processed acquisition measurements, analytical or numerical instrument response, or inversion of the instrument response or data matching processing flow. Further, data may be acquired from one or more physical seismic acquisition devices, such as geophones, as generally described above. Further, the acquired seismic data may be pre-processed, for example, to remove noise therefrom, and/or any other suitable processing may be applied. FIG. 11b illustrates a wavelet profile, as an example of the wavelet as at 3406.

The method 3400 may include generating a wavefield using the input data 3402 and based on the model system 3404 by propagating the wavefield backward in time using a suitable wave propagation engine, along with appropriate time initial conditions, spatial boundary conditions, and source terms, as indicated at 3408, for example, as backward wavefield simulation. The simplest example of backward waveform generation is to solve equations (2) and store p_{R}(\vec{x};t;\vec{x}ₛ). FIG. 12a illustrates an example snap profile of the backward wavefield for the seismic data in FIG. 10b using velocity model in FIG. 11a as at 3408.

The method 3400 may include generating a wavefield using the wavelet or data 3406 and based on the model system 3404 by propagating the wavefield forward in time using a suitable wave propagation engine, along with appropriate time initial conditions, spatial boundary conditions, and source terms, as indicated at 3410, for example, as forward wavefield simulation. The simplest example of forward waveform generation is to solve equation (3) and store p_{S}(\vec{x};t;\vec{x}ₛ). FIG. 12b illustrates an example snap profile of the forward wavefield for the wavelet in FIG. 11b using velocity model in FIG. 11a as at 3410.

The method 3400 may include forming the delayed-time common image gathers (DTCIGs) (Sava, P. and Fomel, S., 2006, “Time-shift imaging condition in seismic migration”: Geophysics, 71, 209-217), as at 3412, for example, as gather forming. The DTCIG r(x; r) may be generated using equation (4). FIGS. 13a and 13b illustrate example DTCIG using the raw wavefields and the processed wavefields through the velocity model in FIG. 11a at a typical spatial position of the surveyed formation as at 3412, respectively. The white line indicates the picked maximum amplitude along the delayed-time direction for all depths. The dashed line indicates the 0 delayed-time lag.

The method 3400 may include a model accuracy/error information extraction process T, such as delayed-time picks, stacks, displays or attributes and so on, as follows:

$$δ m ( \vec{x} ) = T ( r ( \vec{x} ; τ ) ) . \qquad ( 5 )$$

Here, δm(\vec{x}) denotes the model gradient generated from the extracted delayed-time shifts information which describes the model accuracy/error. This process is as at 3414, for example, as model gradient forming.

The method 3400 may include updating the model system using the initial model system 304 and the model gradient in 3414 as at 3434, for example, as model update, as follows:

$$m + α δ m . \qquad ( 6 )$$

Here, α is a scalar which can be manually, automatically, or systematically computed.

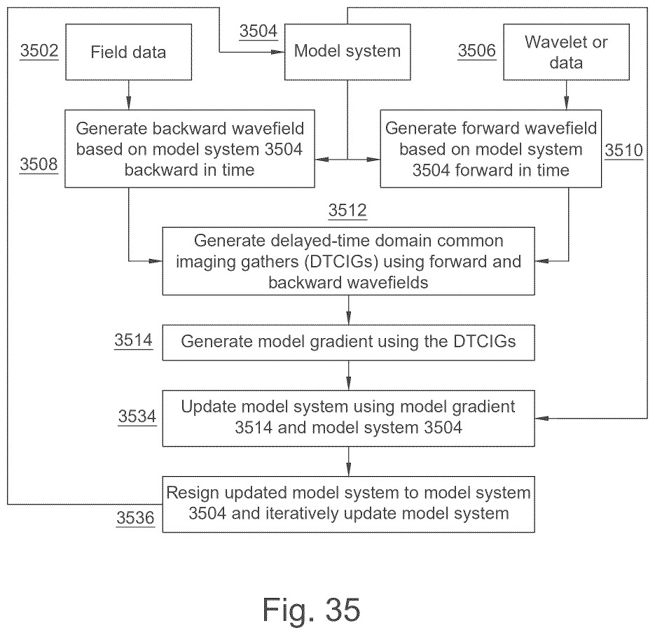

FIG. 35 illustrates a flowchart of a method 3500 for seismic processing for example, using a full waveform inversion, to update model system 3504 automatically according to an embodiment. The method 3500 may include obtaining field data as at 3502, for example, as input. The field data may be acquired from one or more physical seismic acquisition devices, such as geophones, as generally described above. Further, the acquired seismic data may be pre-processed, for example, to remove noise therefrom, and/or any other suitable processing may be applied. FIG. 10b illustrates simplified synthetic seismic data, as an example of the field data as at 3502, generated using the exact p-wave velocity model in FIG. 10a.

The method 3500 may also include an initial model system at the i^{th} iteration of the surveyed formation which helps to describe or simulate waveforms or wavefields within the surveyed formation, as at 3504, for example, as input. The model system may include but is not limited to p-wave velocity model, s-wave velocity model, anisotropy models, elastic parameters, Q model (to describe subsurface attenuation), density model and etc. Further, the model may be constructed based on a model of the subterranean formation. For example, the model system may be based on any available information about the subterranean formation that is known a priori, before the method 3500 is conducted. This may include information about the subterranean formation, general characteristics of the seismic waveforms, etc. FIG. 11a illustrates a simple p-wave velocity model, as an example of the initial model as at 3504, which differs from the exact p-wave velocity model in FIG. 10a.

The method 3500 may also include obtaining wavelet or data, as at 3506, for example, as input. The wavelet may be a result of direct or processed acquisition measurements, analytical or numerical instrument response, or inversion of the instrument response or data matching processing flow. Further, data may be acquired from one or more physical seismic acquisition devices, such as geophones, as generally described above. Further, the acquired seismic data may be pre-processed, for example, to remove noise therefrom, and/or any other suitable processing may be applied. FIG. 11b illustrates a wavelet profile, as an example of the wavelet as at 3506.

The method 3500 may include generating a wavefield using the input data 3502 and based on the model system 3504 by propagating the wavefield backward in time using a suitable wave propagation engine, along with appropriate time initial conditions, spatial boundary conditions, and source terms, as indicated at 3508, for example, as backward wavefield simulation. The simplest example of backward waveform generation is to solve equations (2) and store p_{R}(\vec{x};t;\vec{x}ₛ). FIG. 12a illustrates an example snap profile of the backward wavefield for the seismic data in FIG. 10b using velocity model in FIG. 11a as at 3508.

The method 3500 may include generating a wavefield using the wavelet or data 3506 and based on the model system 3504 by propagating the wavefield forward in time using a suitable wave propagation engine, along with appropriate time initial conditions, spatial boundary conditions, and source terms, as indicated at 3510, for example, as forward wavefield simulation. The simplest example of forward waveform generation is to solve equation (3) and store p_{S}(\vec{x};t;\vec{x}ₛ). FIG. 12b illustrates an example snap profile of the forward wavefield for the wavelet in FIG. 11b using velocity model in FIG. 11a as at 3510.

The method 3500 may include forming the delayed-time common image gathers (DTCIGs) (Sava, P. and Fomel, S., 2006, “Time-shift imaging condition in seismic migration”: Geophysics, 71, 209-235), as at 412, for example, as gather forming. The DTCIG r(\vec{x};τ) may be generated using equation (4). FIGS. 13a and 13b illustrate example DTCIG using the raw wavefields and the processed wavefields through the velocity model in FIG. 11a at a typical spatial position of the surveyed formation as at 3512, respectively. The white line indicates the picked maximum amplitude along the delayed-time direction for all depths. The dashed line indicates the 0 delayed-time lag.

The method 3500 may include a model accuracy/error information extraction process T in equation (5), such as delayed-time picks, stacks, displays or attributes and so on, as at 3514, for example, as model gradient forming.

The method 3500 may include updating the model system using the initial model system 3504 and the model gradient in 3514 as at 3534, for example, as model update, as follows:

$${m}_{i + 1} = {m}_{i} + α δ {m}_{i} . \qquad ( 7 )$$

Here, α is a scalar which can be manually, automatically, or systematically computed to minimize the objective function:

$$E ( {r}_{i + 1} , {v}_{i + 1} ) = \int \int \int T ( {r}_{i + 1} ( \vec{x} ; τ ( {m}_{i + 1} ) ) ) d \vec{x} . \qquad ( 8 )$$

Here, T is a model accuracy/error information extraction process using the DTCIG, such as delayed-time picks, stacks, displays or attributes and so on. The method 3500 may include a model accuracy/error information extraction process T in equation (5), such as delayed-time picks, stacks, displays or attributes and etc, as at 3514, for example, as velocity gradient forming.

The method 3500 may include reassigning the updated model system mᵢ₊₁ in 3534 to the initial model system in 3504 for the next iteration to iteratively update model system, as in 3518, for example, as an iterative model update.

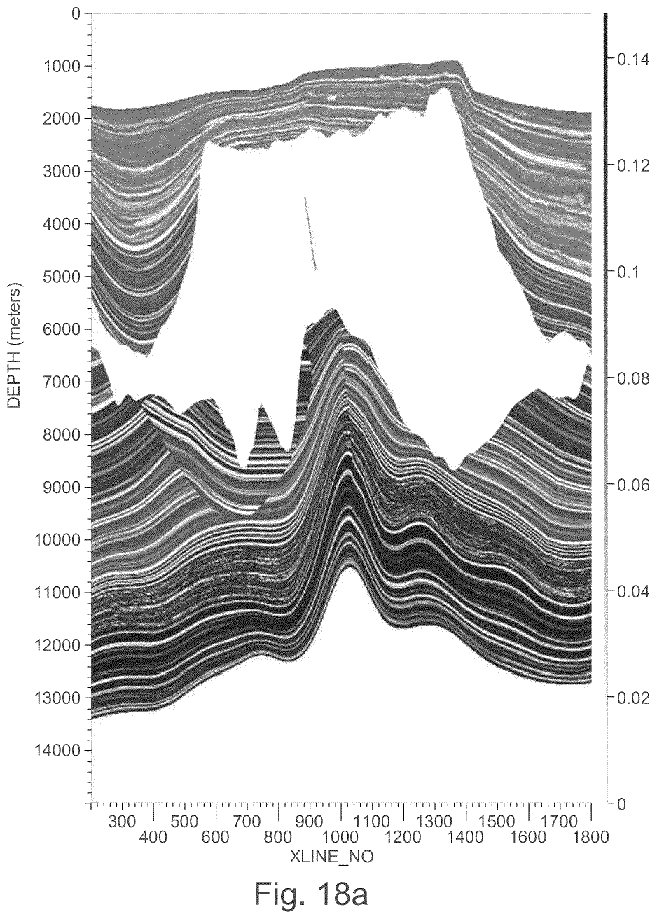

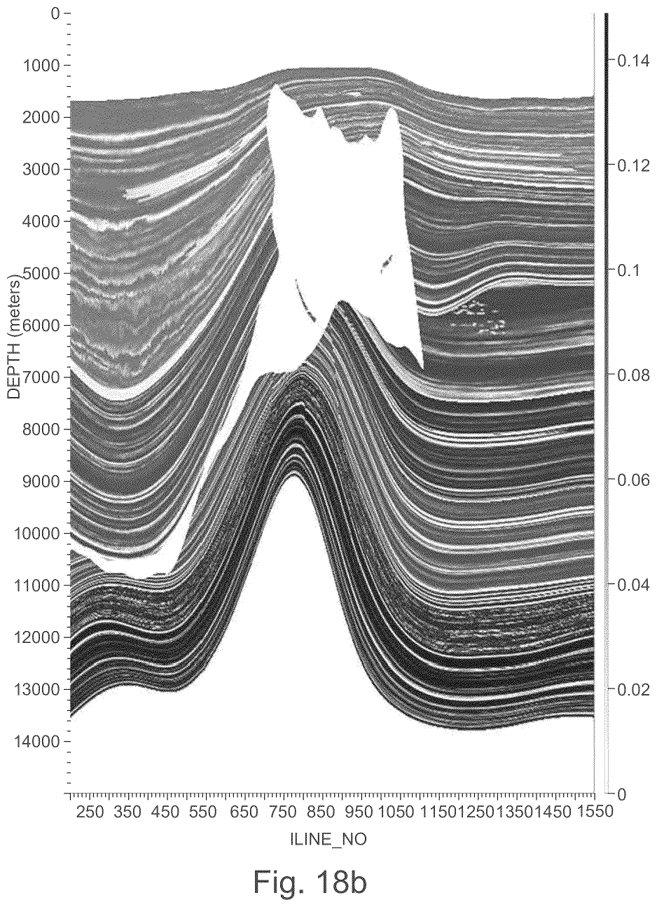

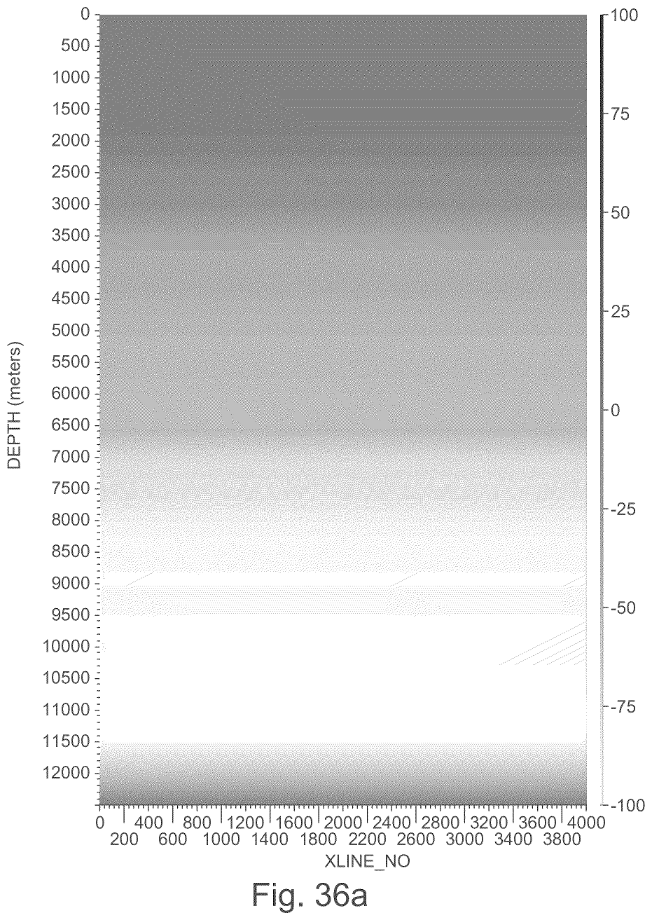

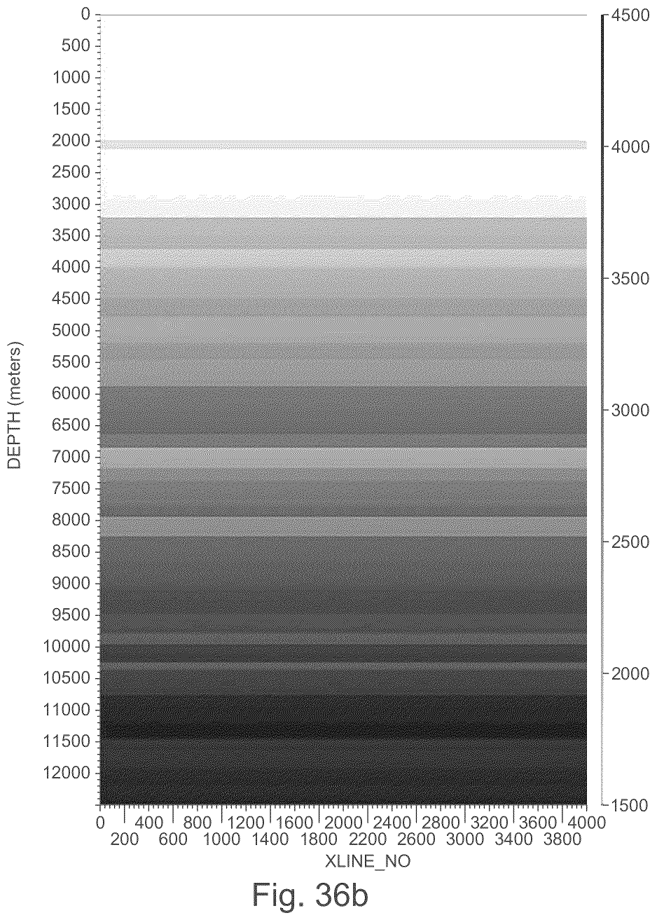

FIG. 36a illustrates a rescaled velocity gradient using the velocity inaccuracy attribute in FIG. 15. It is a process required in equation (7) and as for 3414, 3434, 3514 and 3534. FIG. 36b illustrates an updated velocity using the velocity gradient in FIG. 18a and the initial velocity model in FIG. 11a. It is a process required in equation (7) and as for 3434, 3534 and 3518.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and/or described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

The following disclosure relates to various operations that may be implemented by a computing apparatus configured to execute program instructions specifying said operations. Operations may also be performed by circuitry specifically designed or configured for these operations. In certain embodiments, a non-transitory computer-readable medium stores program instructions capable of causing the operations described herein. The terms “processor,” “processing unit,” or “processing element” refer to different elements or combinations of elements configured to execute program instructions. Processing elements may include, for example, circuits such as Application Specific Integrated Circuits (ASICs), custom processing circuits or gate arrays, parts or circuits of individual processor cores, entire processor cores, individual processors, programmable hardware devices such as field programmable gate arrays (FPGAs) or similar devices, and larger portions of systems containing multiple processors, as well as any combinations thereof.

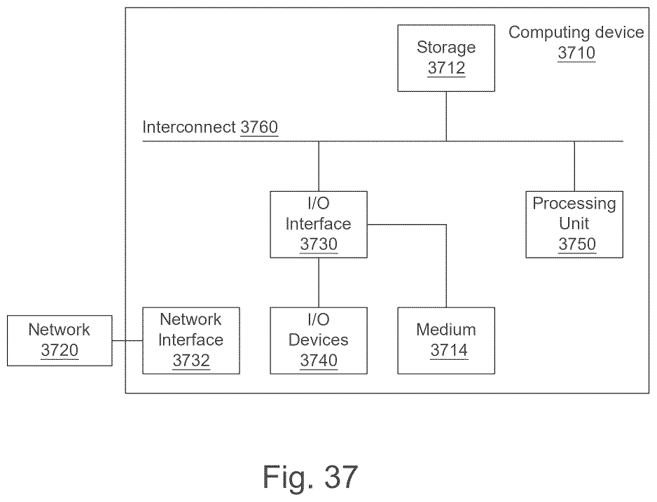

Referring to FIG. 37, a block diagram of an exemplary computing apparatus 3710 is depicted, according to some embodiments. The computing apparatus 3710 may be used to implement various portions of this disclosure. The computing apparatus 3710 serves as an example of a device that may be employed as a mobile device, a server computing system, a client computing system, a distributed computing system, or any other computing system implementing portions of this disclosure. In various configurations, when programmed to execute a specific algorithm, the computing system 3710 may constitute a means for performing a function for which the specific algorithm is a corresponding structure.

The computing apparatus 3710 may include, but is not limited to, a personal computer system, desktop computer, laptop or notebook computer, mobile phone, mainframe computer system, supercomputer, web server, workstation, or network computer. As illustrated, the computing apparatus 3710 comprises a processing unit 3750, a storage subsystem 3712, and an input/output (I/O) interface 3730 connected via interconnect 3760 (for example, a system bus). The I/O interface 3730 may be connected to one or more I/O devices 3740. Additionally, the computing apparatus 3710 includes a network interface 3732, which may be connected to a network 3720 for communication with, for example, other computing devices. Other bus architectures and subsystem configurations may also be employed.

As previously mentioned, the processing unit 3750 includes one or more processors. In certain embodiments, the processing unit 3750 incorporates one or more coprocessor units. In some embodiments, multiple instances of the processing unit 3750 may be connected to the interconnect 3760. The processing unit 3750 (or each processor within the processing unit 3750) may include a cache or other form of onboard memory. In certain embodiments, the processing unit 3750 may be implemented as a general-purpose processing unit, while in other embodiments, it may be implemented as a special-purpose processing unit (for example, an ASIC). The computing apparatus 3710 is not restricted to any particular type of processing unit or processor subsystem.

The storage subsystem 3712, which may comprise system memory and/or virtual memory, is utilized by the processing unit 3750 (for example, to store executable instructions and data used by the processing unit 3750). The storage subsystem 3712 can be implemented using any suitable type of physical memory media, such as hard disk storage, floppy disk storage, removable disk storage, flash memory, random access memory (RAM—SRAM, EDO RAM, SDRAM, DDR SDRAM, RDRAM, etc.), read-only memory (ROM—PROM, EEPROM, etc.), and so forth. In some embodiments, the storage subsystem 3712 may consist solely of volatile memory. The storage subsystem 3712 may store program instructions executable by the computing apparatus 3710 using the processing unit 3750, including program instructions executable to cause the computing apparatus 3710 to implement the various techniques disclosed herein. In at least some embodiments, the storage subsystem 3712 and/or medium 3714 may represent an example of a non-transitory computer-readable or machine-readable medium that may store executable instructions.

In the illustrated embodiment, the computing apparatus 3710 further includes a non-transitory computer-readable medium 3714, which may be distinct from the storage subsystem 3712. As depicted, the computer-readable medium 3714 is configured as a peripheral or I/O device accessible via the I/O interface 3730, although other interconnect configurations are possible. In various embodiments, the non-transitory medium 3714 may include persistent, tangible storage such as disk, nonvolatile memory, tape, optical media, holographic media, or other suitable types of storage. In some embodiments, the non-transitory medium 3714 may be used to store and transfer geophysical data and may be physically separable from the computing apparatus 3710 to facilitate transport. Accordingly, in some embodiments, the geophysical data product discussed above may be embodied in the non-transitory medium 3714. Although shown to be distinct from the storage subsystem 3712, in some embodiments, the non-transitory medium 3714 may be integrated within the storage subsystem 3712. Embodiments of the non-transitory medium 3714 and/or storage subsystem 3712 may correspond to a means for storing recorded seismic data, wavelet, model data, wavefields, DTCIGs, initial models, gradient models and iteratively updated models and may also correspond to a means for storing any I/O related medium intermediately during the process; these means may be distinct structures or may correspond to the same structure.

The I/O interface 3730 may represent one or more interfaces and may be any of various types of interfaces configured to couple to and communicate with other devices, according to various embodiments. In some embodiments, the I/O interface 3730 is a bridge chip from a front-side to one or more back-side buses. The I/O interface 3730 may be coupled to one or more I/O devices 3740 via one or more corresponding buses or other interfaces. Examples of I/O devices include storage devices (hard disk, optical drive, removable flash drive, storage array, Storage Area Network (SAN), or an associated controller), network interface devices, user interface devices, or other devices (for example, graphics, sound, etc.). In some embodiments, the geophysical data product discussed above may be embodied within one or more of the I/O devices 3740.

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

What is claimed is:

1. A method for seismic processing, comprising:
receiving seismic data comprising acquired seismic waveforms that are acquired from a seismic receiver and represent a subterranean area;
generating a backward wavefield using the seismic data or processed seismic data and based on an initial model system by propagating the backward wavefield backward in time;
generating a forward wavefield using a given wavelet or processed seismic data by propagating the forward wavefield forward in time;
generating delayed-time common image gathers (DTCIGs) based on the backward wavefield and forward wavefield;
obtaining delayed-time shift information associated with maximum amplitude of vertically prominent events produced by diving waves or model-generated reflections at each of the DTCIGs;
extracting model accuracy information from DTCIGs for analysis and/or quality control based on the obtained delayed-time shift information;
determining a model error from either the model accuracy information and/or the DTCIGs for analysis and/or quality control; and
adjusting the initial model system based on the model error to generate an adjusted/updated model.

2. The method of claim 1, wherein determining the model error comprises determining a delayed-time shift objective function in a model domain, wherein the delayed-time shift objective function represents delayed-time shifts extracted from the DTCIGs.

3. The method of claim 2, wherein determining the model error further comprises determining a local delayed-time shift error.

4. The method of claim 3, wherein determining the local delayed-time shift error comprises directly minimizing the delayed-time shift objective function as a local attribute.

5. The method of claim 3, wherein determining the model error further comprises translating the delayed-time shift error to an instantaneous model domain amplitude and/or phase error.

6. The method of claim 5, wherein determining the model error further comprises determining an instantaneous amplitude and/or phase objective function relation based on the instantaneous amplitude and/or phase error.

7. The method of claim 5, wherein determining the model error further comprises forming model update gradient using the instantaneous amplitude and/or phase error.

8. The method of claim 5, wherein determining the model error further comprises computing amplitude and/or phase objective function using the instantaneous amplitude and/or phase error.

9. The method of claim 1, further comprising performing a full waveform inversion using the adjusted model as a background model.

10. The method of claim 9, further comprising interpreting one or more characteristics of the subterranean area based on a result of the full waveform inversion.

11. The method of claim 1 further comprising creating an image of the subterranean area, and locating a natural resource in the subterranean area based on the image.

12. A computing system, comprising:
a processor; and
a memory comprising a non-transitory, computer-readable media storing instructions that, when executed by the processor, causes the computing system to perform an operation, comprising:
receiving seismic data comprising acquired seismic waveforms that are acquired from a seismic receiver and represent a subterranean area;
generating a backward wavefield using the seismic data or processed seismic data and based on an initial model system by propagating the backward wavefield backward in time;
generating a forward wavefield using a given wavelet or processed seismic data by propagating the forward wavefield forward in time;
generating delayed-time common image gathers (DTCIGs) based on the backward wavefield and forward wavefield;
obtaining delayed-time shift information associated with maximum amplitude of vertically prominent events produced by diving waves or model-generated reflections at each of the DTCIGs;
extracting model accuracy information from DTCIGs for analysis and/or quality control based on the obtained delayed-time shift information;
determining a model error from either the model accuracy information and/or the DTCIGs for analysis and/or quality control; and
adjusting the initial model system based on the model error to generate an adjusted/updated model.

13. The system of claim 12, wherein determining the model error comprises determining a delayed-time shift objective function in a model domain, wherein the delayed-time shift objective function represents delayed-time shifts extracted from the DTCIGs.

14. The system of claim 13, wherein determining the model error further comprises determining a local delayed-time shift error.

15. The system of claim 14, wherein determining the local delayed-time shift error comprises directly minimizing the delayed-time shift objective function as a local attribute.

16. The system of claim 14, wherein determining the model error further comprises translating the delayed-time shift error to an instantaneous model domain amplitude and/or phase error.

17. The system of claim 16, wherein determining the model error further comprises determining an instantaneous amplitude and/or phase objective function relation based on the instantaneous amplitude and/or phase error.

18. The system of claim 16, wherein determining the model error further comprises forming model update gradient using the instantaneous amplitude and/or phase error.

19. The system of claim 16, wherein determining the model error further comprises computing amplitude and/or phase objective function using the instantaneous amplitude and/or phase error.

20. The system of claim 12, further comprising performing a full waveform inversion using the adjusted model as a background model.

21. The system of claim 20, further comprising interpreting one or more characteristics of the subterranean area based on a result of the full waveform inversion.

22. A non-transitory, computer-readable medium storing instructions that, when executed by a processor of a computing system, causing the computing system to perform an operations comprising:
receiving seismic data comprising acquired seismic waveforms that are acquired from a seismic receiver and represent a subterranean area;
generating a backward wavefield using the seismic data and based on an initial model system by propagating the backward wavefield backward in time;
generating a forward wavefield using a given wavelet or processed seismic data by propagating the forward wavefield forward in time;
generating delayed-time common image gathers (DTCIGs) based on the backward wavefield and forward wavefield;
obtaining delayed-time shift information associated with the maximum amplitude of vertically prominent events produced by diving waves or model-generated reflections at each of the DTCIGs;
extracting model accuracy information from DTCIGs for analysis and/or quality control based on the obtained delayed-time shift information;
determining a model error from either the model accuracy information and/or the DTCIGs for analysis and/or quality control; and
adjusting the initial model system based on the model error to generate an adjusted/updated model.

23. The medium of claim 22, wherein determining the model error comprises:
determining the local delayed-time shift error comprises directly minimizing the delayed-time shift objective function as a local attribute.
translating the delayed-time shift error to an instantaneous model domain amplitude and/or phase error.
determining an instantaneous amplitude and/or phase objective function relation based on the instantaneous amplitude and/or phase error.
forming model update gradient using the instantaneous amplitude and/or phase error.
computing amplitude and/or phase objective function using the instantaneous amplitude and/or phase error.
performing a full waveform inversion using the adjusted model as a background model.
